(19) United States
(12) Patent Application Publication
(10) Pub. No.: US 2008/0216926 A1
(43) Pub. Date: Sep. 11, 2008

(54) ULTRA-SHORT DURATION LASER METHODS FOR THE NANOSTRUCTURING OF MATERIALS

(76) Inventors: Chunlei Guo, Rochester, NY (US); Anatoliy Y. Vorobyev, St. Catherines (CA)

Correspondence Address: BOND, SCHOENECK & KING, PLLC, 10 BROWN ROAD, SUITE 201, ITHACA, NY, 14850-1248, US

(21) Appl. No.: 11/862,449

(22) Filed: Sep. 27, 2007

Related U.S. Application Data
(60) Provisional application No. 60/847,916, filed on Sep. 29, 2006.

(51) Int. Cl. C21D 1/09; B23K 26/00

(52) U.S. Cl. 148/565; 219/121.85

(57) ABSTRACT

The present invention is generally directed to the materials processing regimes obtained with laser processing using ultra-short laser pulses of subpicosecond (i.e., up to hundreds of femtoseconds) duration, and to the altered materials obtained through such materials processing regimes. Thus various aspects of the present invention are directed to, for example, methods for altering materials by exposure of the materials to one or more pulses of a fs duration laser, while other aspects of the present invention are directed to, for example, materials altered by the methods of the invention. These macro-, micro-, and nanostructured materials have a variety of applications, including, for example, aesthetic applications such as jewelry or ornamentation; biomedical applications, especially medical applications involving biocompatibility bioperformance; catalysis applications; and modification of, for example, the optical and hydrophilic properties of materials.

### PRIORITY

This patent application claims priority to U.S. Provisional Application Ser. No. 60/847,916, filed Sep. 29, 2006, the contents of which is incorporated in its entirety by reference.

### FEDERAL FUNDING

The work described herein was funded, in whole or in part, by grants from the National Science Foundation. Consequently, the federal government has certain rights in this invention.

### BACKGROUND OF THE INVENTION

Although materials may be shaped or otherwise altered in a large variety of ways including milling, machining, grinding, etc., in recent years laser-based alteration of materials has become a preferred method for a variety of materials processing applications. Thus for example laser alteration of materials by a high energy laser pulse or pulses has been used to create precise alterations in materials including both material removal to create precise hole patterns in metals or metal films, as well as more subtle material alterations such as texturing of metals or metal films by the intense heating/melting/vaporization effects of such high energy laser beams, etc.

One preferred method of laser alteration of materials involves the use of a short-pulsed laser beam of a duration on the order of nanoseconds or picoseconds. Thus for example U.S. Pat. No. 5,635,089 uses a laser beam having a pulse duration of between 15-25 nanoseconds (ns) to obtain a variety of alterations in the surfaces of materials including hydroxyapatite, silicon nitride, alumina, stainless steel, etc., and describes the use of even shorter pulses in the picosecond (ps) duration range to accomplish similar alterations in materials. See also, e.g., U.S. Pat. No. 4,972,061, which describes surface roughening effects obtained with pulses of typically 30 ns duration.

In addition to short pulses of nanosecond or picosecond duration, ultra-short pulses of sub-picosecond duration may also be used for material alteration. Thus for example U.S. Pat. No. 6,979,798 describes the use of laser pulses of preferably less than 130 femtoseconds (fs) to alter materials by specifically (and only) burning metal links on integrated circuits using such ultra-short duration laser pulses delivered at the high energy density (fluence) required to obtain such burning.

Although as discussed above both short and ultra-short laser pulses can be used for material alterations, because the physical effects of laser pulses of different duration on the materials being processed are generally very different, ultra-short duration laser processing of materials offers up the promise of achieving results that are not obtainable with longer duration laser pulses. Thus for example in short duration laser irradiation, as material is ejected from the surface of the material it interacts with the laser beam, which because of its duration, is still on during this expansion. In ultra-short laser pulses, by comparison, there is no interaction between the laser beam and material ejected from the surface of the irradiated substance since the beam ends long before the hydrodynamic expansion of the ejected material is sufficient for such interaction. Another difference between different laser pulse timescales is that the laser-supported combustion and detonation waves that are commonly generated in a nanosecond duration laser pulse do not occur in an ultra-short laser pulse of sub-picosecond duration, again offering up the possibility of materials processing effects and ultimately altered materials that may be difficult or impossible to obtain with longer duration laser irradiation.

In light of the above observations that short duration and ultra-short duration laser processing methods can produce very different results on the materials thus processed, it would be highly advantageous to better understand and utilize the unique effects on materials obtained for these different pulse duration processing methods, and more particularly obtain an understanding and utilization of the various unique effects on materials processing that are obtained through ultra-short duration laser pulses, including various unique effects that are specifically identified and characterized in the present invention.

### SUMMARY OF THE INVENTION

The present invention is generally directed to the materials processing regimes obtained with laser processing using ultra-short laser pulses of subpicosecond (i.e., up to hundreds of femtoseconds) duration, and to the altered materials obtained through such materials processing regimes.

Thus various aspects of the present invention are directed to methods for altering materials by exposure of the materials to one or more pulses of a fs duration laser. In one embodiment, the material exposed to the laser beam is a bulk metal. In other embodiments: the fluence of the laser beam is less than 2 J/cm²; the exposure of the material to the laser beam is done in a non-vacuum environment; the number of laser pulses is at least 2; the area of the material altered is at least 0.5 cm²; and, the alteration of the material produces an absorptance of the material of at least 0.9. This list of embodiments is merely illustrative of some of the various aspects of the present invention and is not intended to be definitive or limiting.

Other aspects of the present invention are directed to materials altered by the methods of the invention. Thus in one embodiment, the present invention is directed to a material having nanoprotrusions with spherical tips of diameter of up to about 75 nm. In another aspect, the present invention is directed to a material having an absorptance of at least 0.9. As for the methods of the invention, this list of embodiments is merely illustrative of some of the various aspects of the present invention and is not intended to be definitive or limiting.

Other features and advantages of the present invention will become apparent from the following detailed description and claims and the appended drawings.

### BRIEF DESCRIPTION OF THE DRAWINGS

The following drawings are provided in order to provide further description of the present invention. These drawings are not intended to limit the present invention in any way.

In the drawings:

FIGS. 1-7 derive from the manuscript published as Phys. Rev. B 72 (2005) 195422;

FIGS. 8-15 derive from the manuscript published as Appl. Phys. A 82 (2006) 357-363;

FIGS. 16-20 derive from the manuscript published as Optics Express 14 (2006) 2164-2169;

FIGS. 21-25 derive from the manuscript published as J. Appl. Phys. 101, 034903 (2007); and

FIGS. 26-33 derive from the manuscript published as Appl. Surf. Sci. 253, 7272-7280 (2007); and,

FIGS. 34-36 refer to application of the materials processing techniques of the present invention to the production of grayed and colored metals, as detailed in the unpublished discussion of Example 6 below.

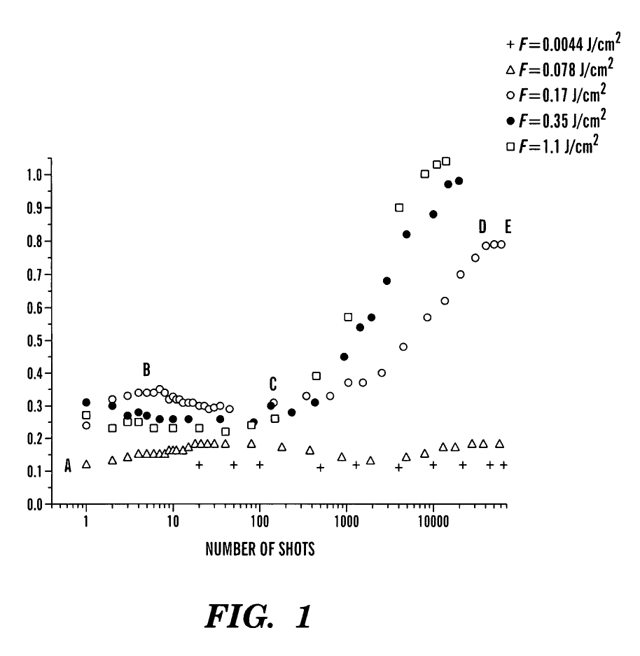

FIG. 1 provides the absorptance of a gold (Au) surface measured after this surface had been exposed to one or more shots of varying fluence of a Ti:sapphire laser (central wavelength of 0.8 um; pulse duration of 60 fs). This figure shows that irradiation of the Au surface produces four different regimes for absorptance change: AB, BC, CD, and DE.

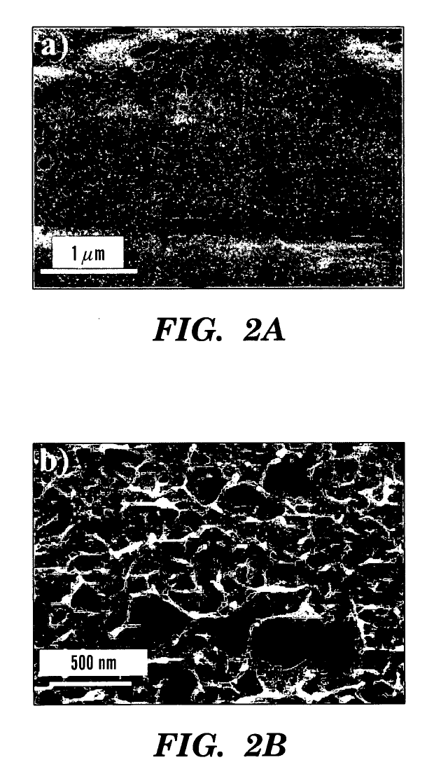

FIG. 2 provides scanning electron micrograph (SEM) images of a gold surface (a) before irradiation and (b) after one shot at a fluence (F)=1.1 J/cm² of the laser described in the legend to FIG. 1. This nanoscale roughness produced by ablation enhances the absorptance by a factor of 2 (region AB in FIG. 1).

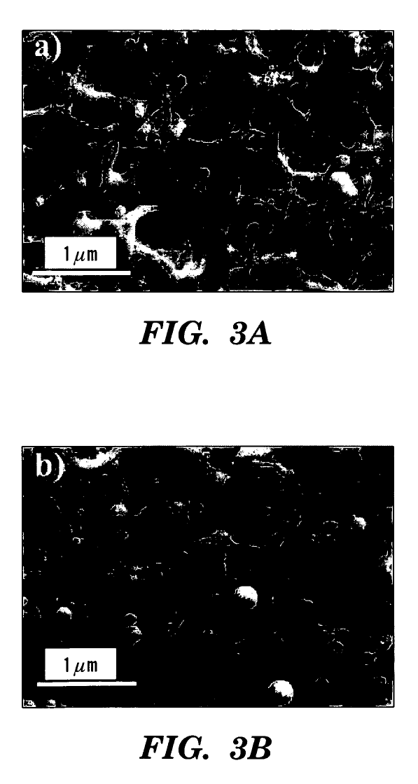

FIG. 3 provides SEM images of nanoscale surface structural features produced on a gold surface at a fluence of F=1.1 J/cm² (region BC of FIG. 1) of the laser described in the legend to FIG. 1. (a) Nanobranches after 2 shot ablation. (b) Spherical nanoparticles after 5 shot ablation.

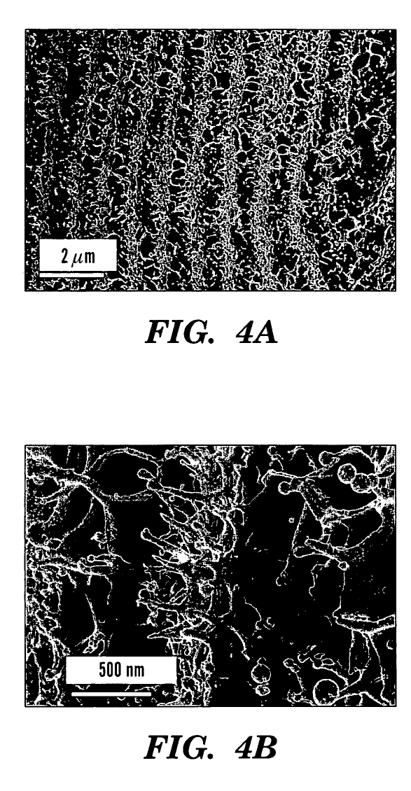

FIG. 4 provides SEM images showing laser induced periodic surface structures (LIPSS) in the irradiated area after 20,000 shots at a fluence of F=0.17 J/cm² (region CD in FIG. 1) of the laser described in the legend to FIG. 1. (a) SEM micrograph showing the period of LIPSS. (b) Nanobranches and supported spherical nanoparticles in the LIPSS.

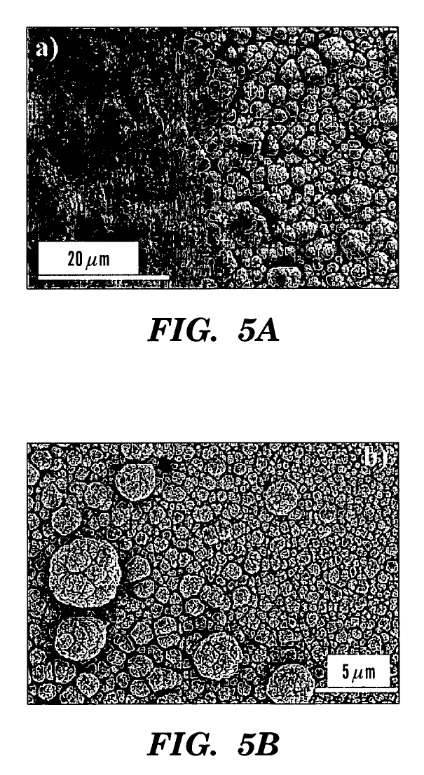

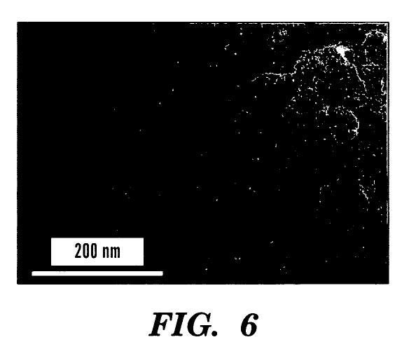

FIG. 5 provides SEM images showing (a) LIPSS on the periphery of the irradiated area and gold-black deposit outside the irradiated area after 10,000 shots at a fluence of F=1.1 J/cm² (region DE in FIG. 1) of the laser described in the legend to FIG. 1. (b) Gold-black deposit after 20,000 shots at F=0.17 J/cm² (region CD in FIG. 1). The gold-black layer consists of spherical aggregates with a mean diameter that decreases as the distance from the crater increases. A spherical aggregate consists of spherical nanoparticles. See, e.g., FIG. 6.

FIG. 6 provides an SEM image of spherical nanoparticles in a spherical aggregate of the gold-black deposit. The laser used is the laser described in the legend to FIG. 1.

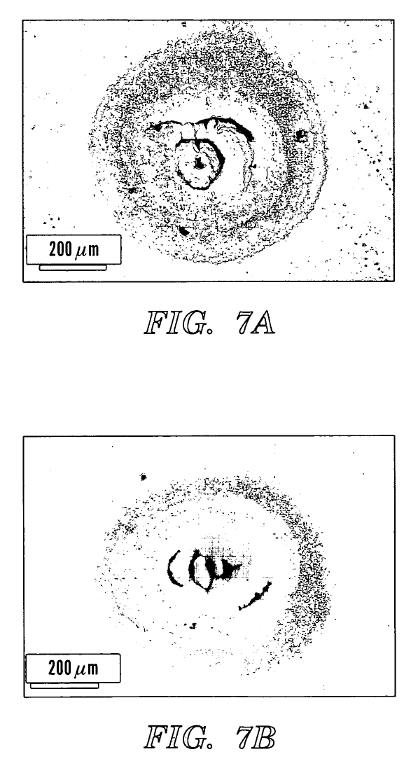

FIG. 7 provides SEM images of (a) a crater produced by 5,000 shots at F=0.17 J/cm²; the absorptance of this ablated spot is 0.45. (b) SEM image of a crater produced by 5,000 shots at F=1.1 J/cm²; the absorptance of this ablated spot is 0.85. In both cases the laser used is the laser described in the legend to FIG. 1.

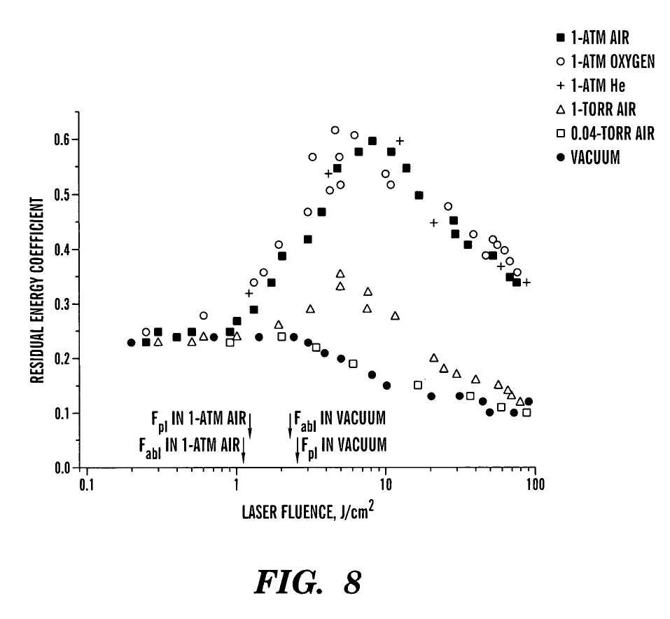

FIG. 8 provides the residual energy coefficients of aluminum (Al) versus laser fluence following ablation with a single 55 ns pulse of a Nd:YAG laser at various ambient gas conditions. The base pressure of the vacuum used for these experiments is about 0.01 torr.

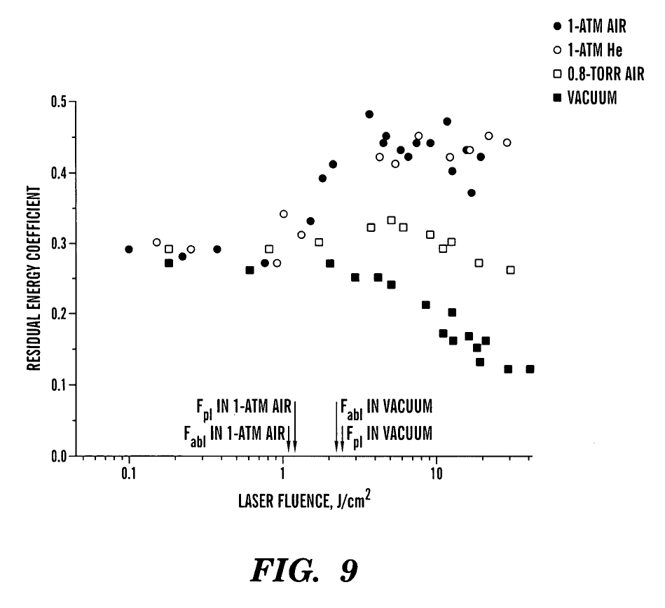

FIG. 9 provides the residual energy coefficients for aluminum versus laser fluence following ablation with a single 45 ns pulse of a ruby laser at various ambient gas conditions. The base pressure of the vacuum used is again about 0.01 torr.

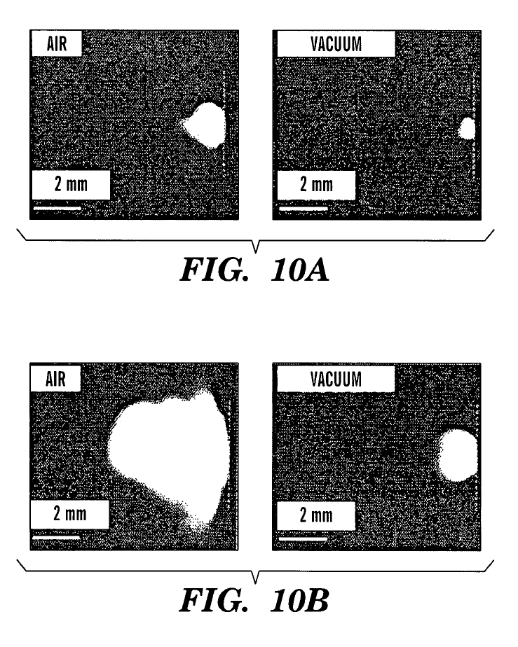

FIG. 10 provides open-shutter photographs of plasmas produced by 55 ns Nd:YAG laser pulses in 1 atm air and in vacuum at (a) F=4.7 J/cm² and (b) F=19.5 J/cm². The laser beam is normally incident on the sample from the left. The white dashed lines indicate the front surface of the sample. The diameter of the laser spot on the sample is 1.5 mm.

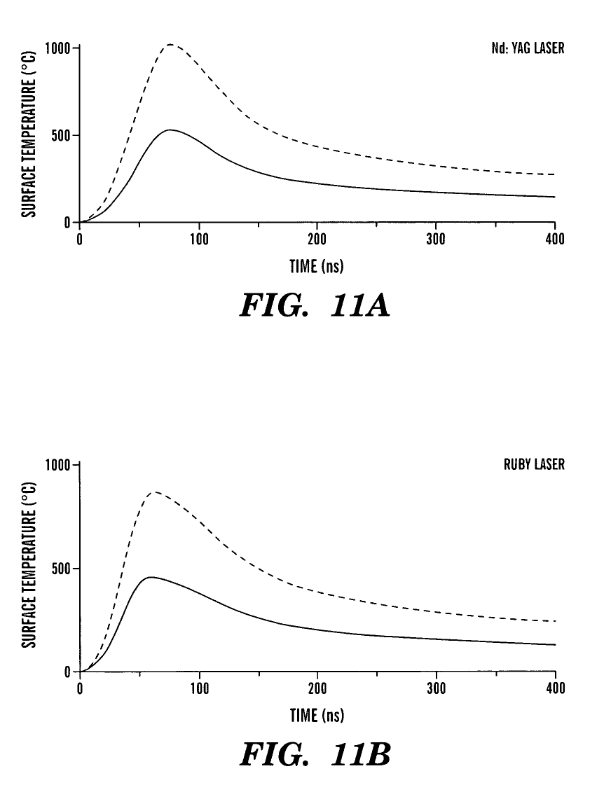

FIG. 11 provides (a) estimates of surface temperatures of Al samples for a Nd:YAG laser pulse at F_{ab1} approximately equal to Fₚₗ=1.4 J/cm² in 1 atm air (solid line) and at F_{ab1} approximately equal to Fₚₗ=2.7 J/cm² in vacuum at a base pressure of 0.01 torr (dotted line). (b) Estimated surface temperatures of Al samples for a ruby laser pulse at F_{ab1} approximately equal to Fₚₗ=1.1 J/cm² in 1 atm air (solid line) and at F_{ab1} approximately equal to Fₚₗ=2.1 J/cm² in vacuum at a base pressure of 0.01 torr (dotted line).

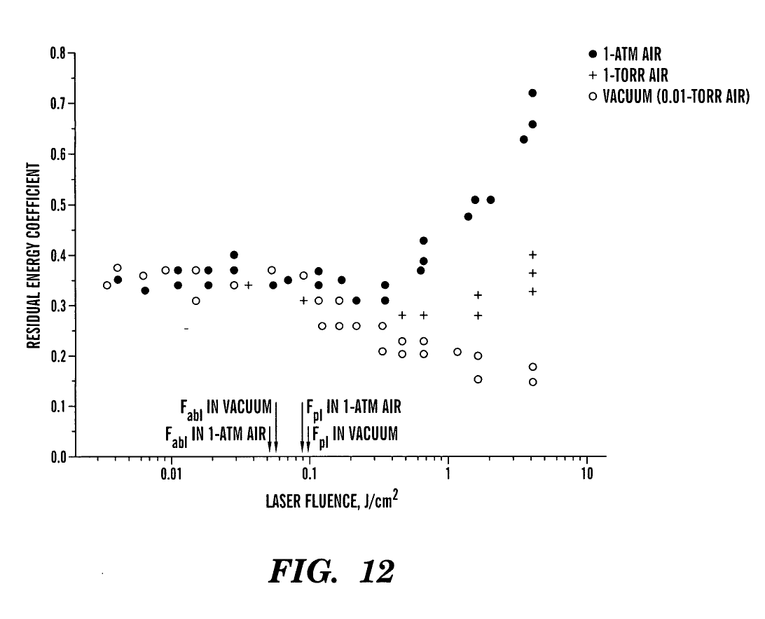

FIG. 12 provides the residual energy coefficients of Al in air at various pressures versus laser fluence following single pulse fs laser ablation using a Ti:sapphire laser producing 60 fs pulses with a central wavelength of about 0.8 um. The base vacuum pressure is about 0.01 torr.

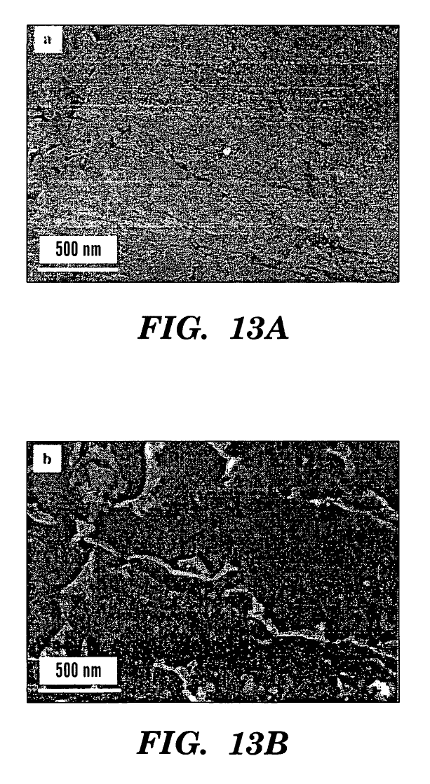

FIG. 13 provides SEM images of (a) a mechanically polished Al surface before laser irradiation and (b) a typical surface modification of the Al after 1 shot at F=F_{abl}=0.053 J/cm² in 1 atm air using the fs laser described in the legend to FIG. 12. Surface defects are preferential spots for ablation. A few small spherical nanoparticles are seen on the surface.

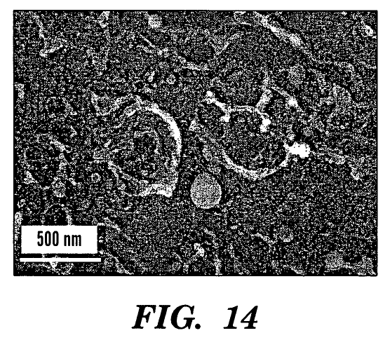

FIG. 14 provides SEM images of the Al surface after 1 shot at F=Fₚₗ=0.086 J/cm² in 1 atm air using the fs laser described in the legend to FIG. 12. Surface defects are preferential spots for ablation. The number and size of spherical nanoparticles on the surface are greater than those at F=F_{abl} (i.e., than in FIG. 13(b)).

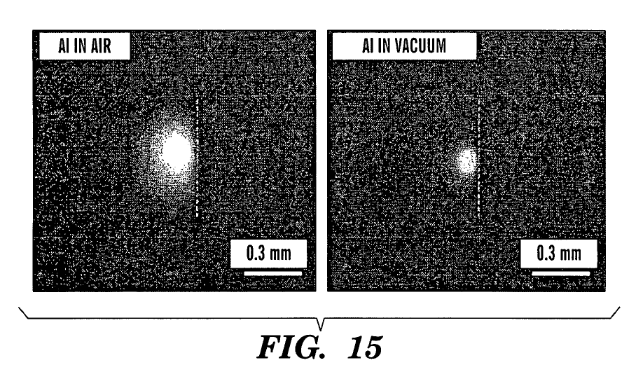

FIG. 15 provides open shutter photographs of plasma produced by single pulse fs laser ablation at F=1.16 J/cm² in 1 atm in vacuum (pressure of about 0.01 torr) using the fs laser described in the legend to FIG. 12. The laser beam is normally incident on the target from the left. The white dashed line indicates the front surface of the sample. The diameter of the laser spot on the sample is 0.3 mm.

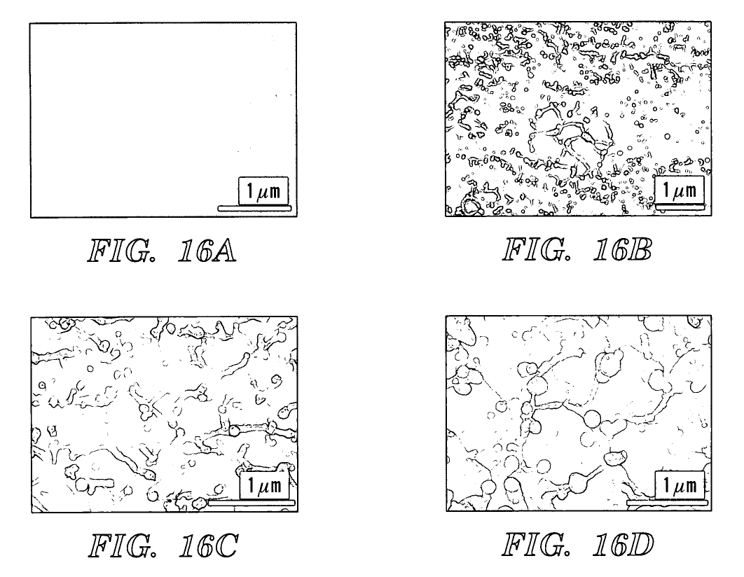

FIG. 16 provides SEM images of nanoscale structures in the center of the irradiated spot on copper following ablation at F=0.35 J/cm² using a Ti:sapphire laser with a central wavelength of 0.8 um and a pulse duration of 65 fs. (a) Sample surface before irradiation. (b) A different area of the copper surface after one shot ablation showing random fine nanostructures in the form of nanoprotrusions, nanocavities, and nanorims. (c) After two shot ablation. (d) After 1,000 shot ablation.

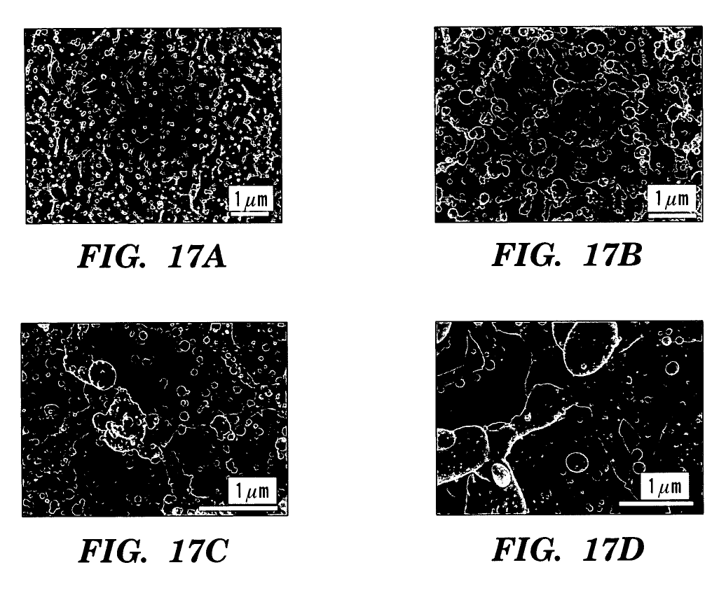

FIG. 17 provides SEM images of the central part of the irradiated spot on copper following ablation at F=1.52 J/cm² using the laser described in the legend to FIG. 16. (a) Surface after 1 shot exhibiting random nanostructures in the form of nanoprotrusions and nanocavities. (b) Surface after two shot ablation showing random nanostructures in the form of spherical nanoprotrusions and nanocavities. (c) Surface after 10 shots showing both nano- and microstructures. (d) Surface after 1,000 shots showing predominantly microstructures.

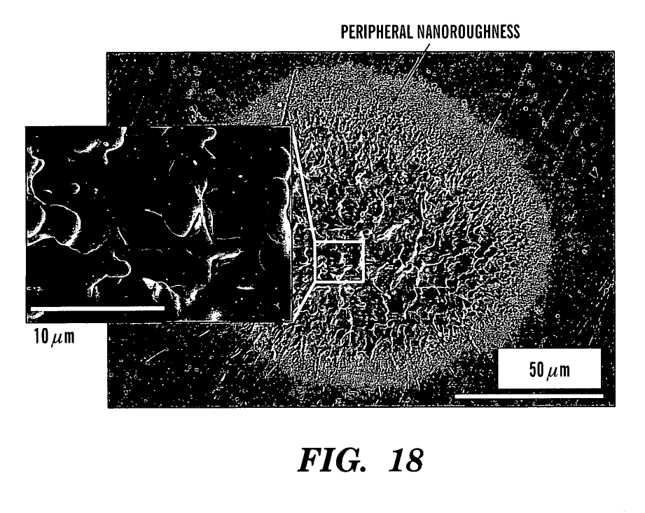

FIG. 18 provides SEM images of copper following 2 shot ablation at F=9.6 J/cm² using the laser described in the legend to FIG. 16. Only microstructures are present in the central area. However, nanostructures are observed on the periphery of the ablated spot. The insert shows microstructural details in the central area.

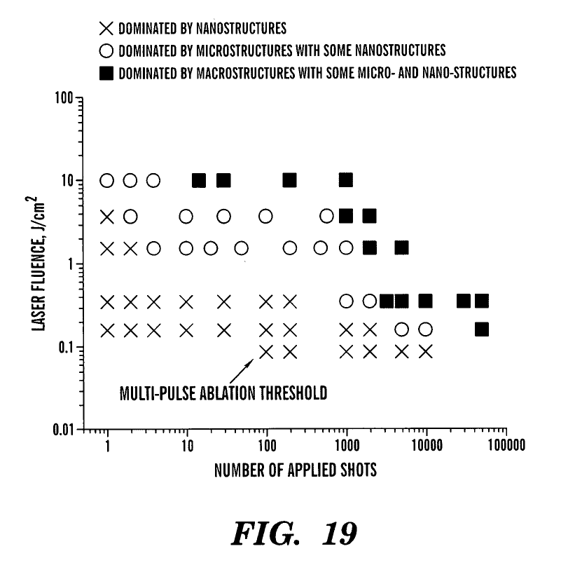

FIG. 19 provides a summary graphic of the different types of structural features observed under SEM on the copper surface as a function of laser fluence and number of shots. These data are derived using the ultra-short fs duration laser pulses obtained from the laser described in the legend to FIG. 16.

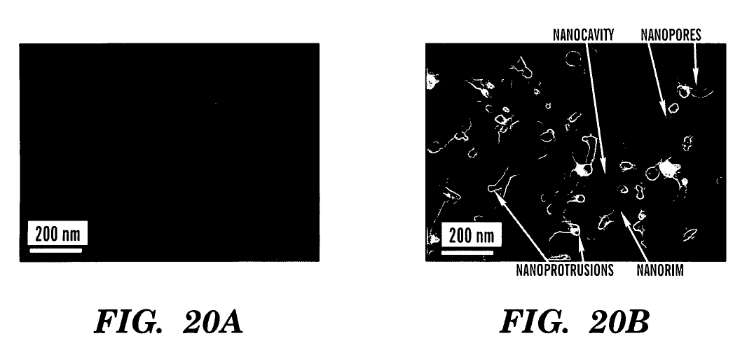

FIG. 20 provides (a) a typical image of a copper sample surface before irradiation and (b) nascent nanostructures formed on copper by ablation at F=0.35 J/cm² with a single laser pulse using the laser described in the legend to FIG. 16. Note that FIG. 20(a) does not show exactly the same spot as FIG. 20(b).

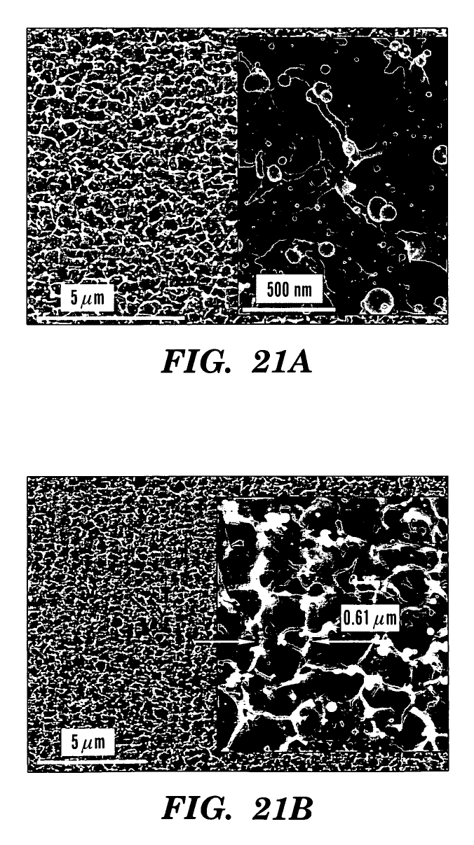

FIG. 21 provides SEM images showing the evolution of laser induced periodic surface structures (LIPSS) in the central area of the irradiated spot on platinum (Pt) at F=0.16 J/cm² delivered from a Ti:sapphire laser system that generates 65 fs pulses with a central wavelength of 0.8 um. (a) Initial random nanoroughness formed after 10 shots (the inset shows a detailed view of the nanoroughness). (b) Nanostructure-covered LIPSS after 30 shots (the inset shows a detailed view).

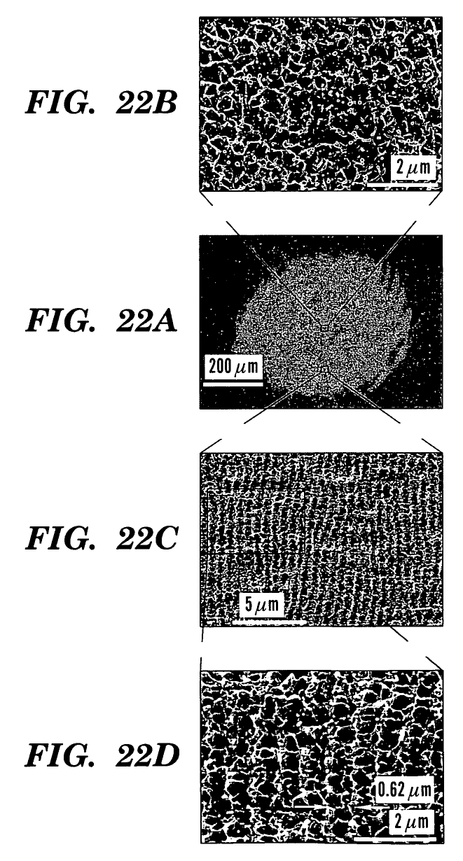

FIG. 22 provides SEM images showing the formation of LIPSS in the peripheral area of the irradiated spot on Pt at F=0.16 J/cm² with 100 shots using the laser described in the legend to FIG. 21. (a) General view of ablated spot. (b) The magnified details show that LIPSS disappears in the central area. (c) Nanostructure-covered LIPSS with a period of 0.62 um in the peripheral area. (d) Further magnified detail of (c).

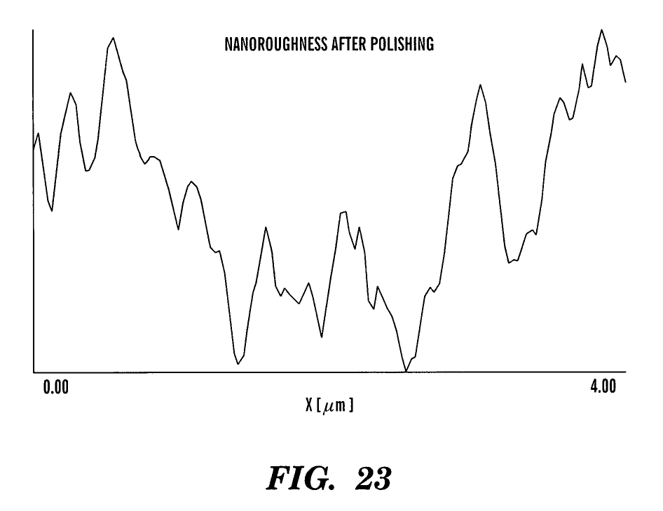

FIG. 23 provides Atomic Force Microscopy (AFM) measurements of the surface profile following (a) mechanical polishing and (b) 10 laser shots using the laser described in the legend to FIG. 21.

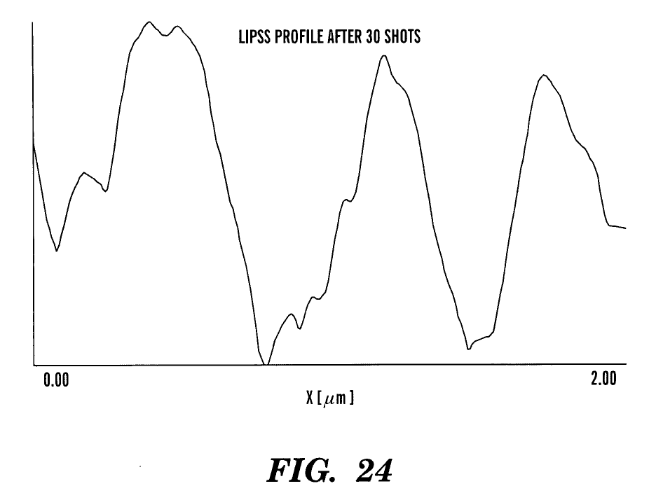

FIG. 24 provides a LIPSS profile measured with AFM following 30 laser shots using the laser described in the legend to FIG. 21.

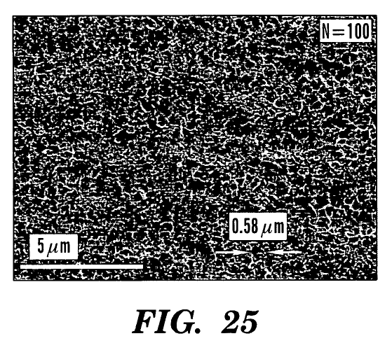

FIG. 25 provides SEM images showing nanostructure-covered LIPSS with a period of 0.58 um in the central area of the irradiated spot on Au after 100 shots at a fluence of F=0.16 J/cm² are delivered using the laser described in the legend to FIG. 21.

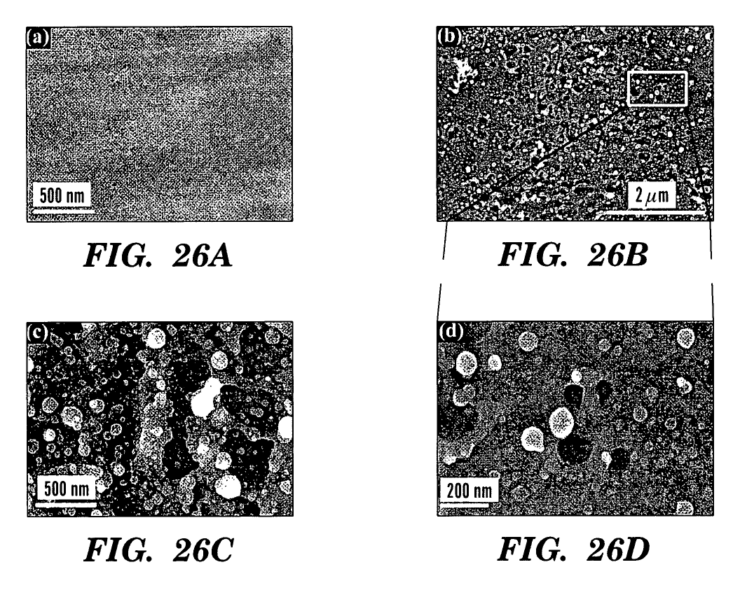

FIG. 26 provides SEM images of nanoroughness on titanium (Ti) following fs laser treatment at near damage threshold fluence of F=0.067 J/cm² using a Ti:sapphire laser system that generates 65 fs pulses with a central wavelength of 0.8 um. (a) Sample surface before irradiation. (b) Nanoroughness after 2 shot laser treatment. (c) After 10 shot treatment. (d) A magnified view of a section in (b) showing fine surface nanostructures in the forms of nanopores and nanoprotrusions typically of spherical shape.

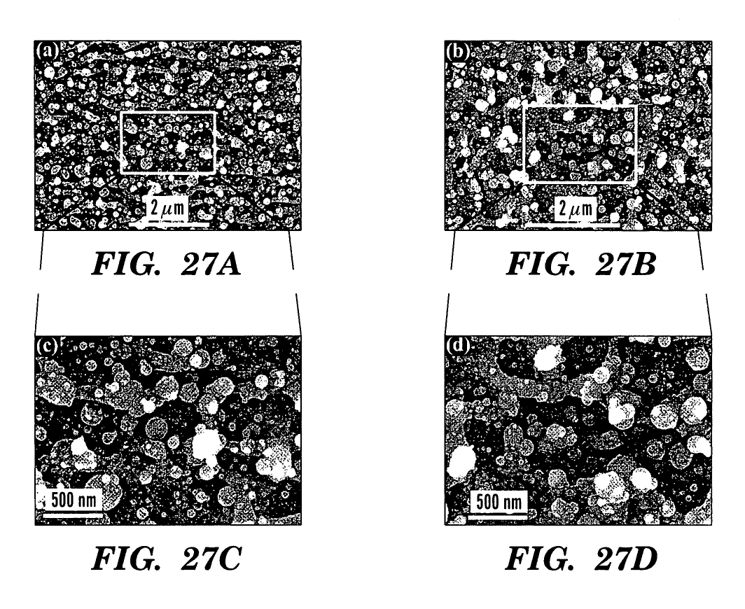

FIG. 27 provides SEM images showing the nanotopography of Ti following femtosecond laser treatment at F=0.084 J/cm² using the laser described in the legend to FIG. 26. (a) Nanoroughness after 1 shot. (b) Nanoroughness after 2 shots. (c) A magnified view of a section in (a) showing fine details of surface nanoroughness. (d) Magnified view of a section in (b) showing fine details of surface nanoroughness.

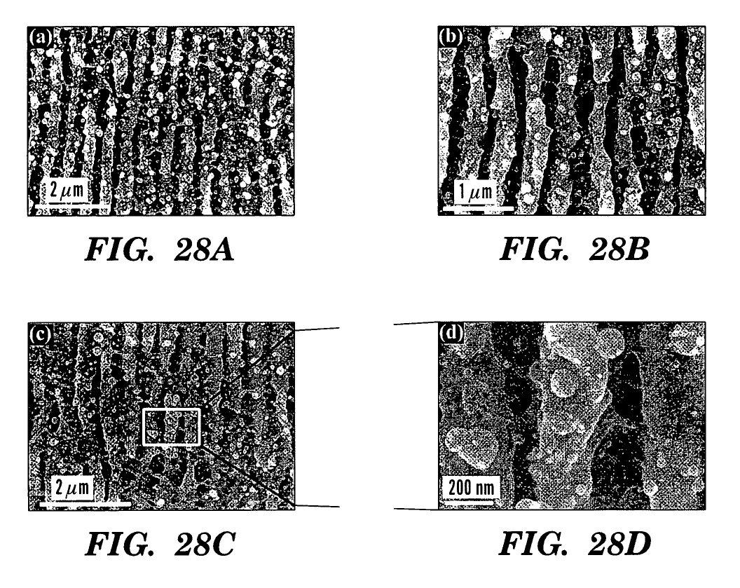

FIG. 28 provides SEM images showing fs laser produced periodic surface patterns on Ti following laser treatment at F=0.067 J/cm² using the laser described in the legend to FIG. 26. (a) Periodic surface pattern after 40 shots. (b) Periodic surface pattern after 100 shots. (c) Periodic surface pattern after 400 shots. (d) A magnified view of a section in (c) showing fine details of the periodic pattern covered with nanostructural features.

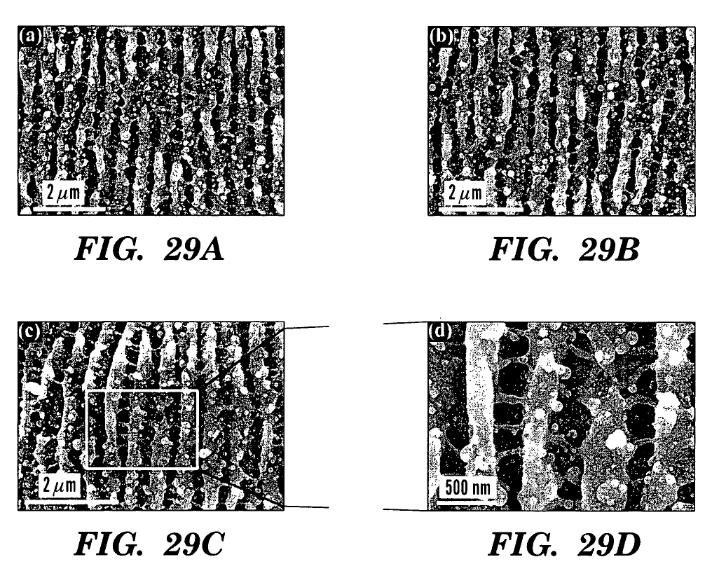

FIG. 29 provides SEM images showing fs laser produced periodic surface patterns on Ti following laser treatment at F=0.084 J/cm² using the laser described in the legend to FIG. 26. (a) Periodic surface pattern after 20 shots. (b) Periodic surface pattern after 400 shots. (c) Periodic surface pattern after 800 shots. (d) A magnified view of a section in (c) showing fine details of the periodic pattern covered with nanostructural features.

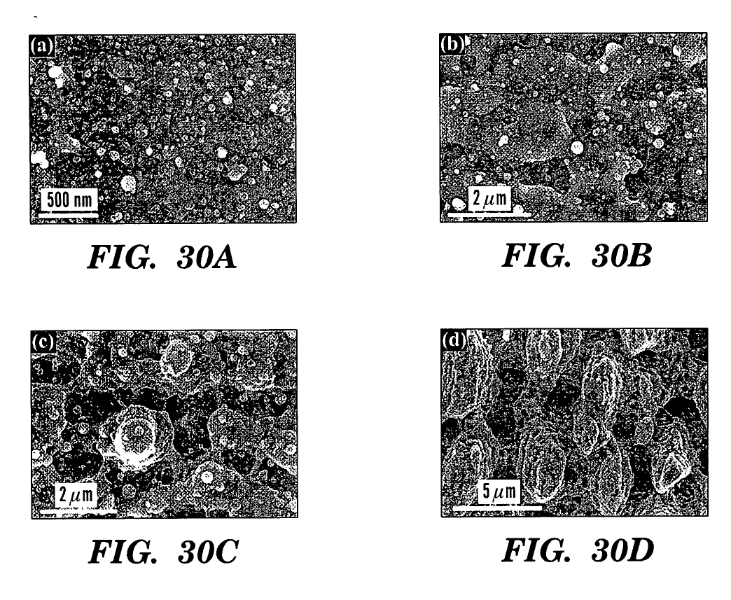

FIG. 30 provides SEM images showing the surface nano- and microtopography of Ti following fs laser treatment at F=0.16 J/cm² using the laser described in the legend to FIG. 26 (a) Nanoroughness after 1 shot. (b) Nano- and microroughness after 20 shots. (c) Typical microroughness covered with nanostructures after 40 shot treatment. (d) Typical columnar microstructure after 200 shot treatment.

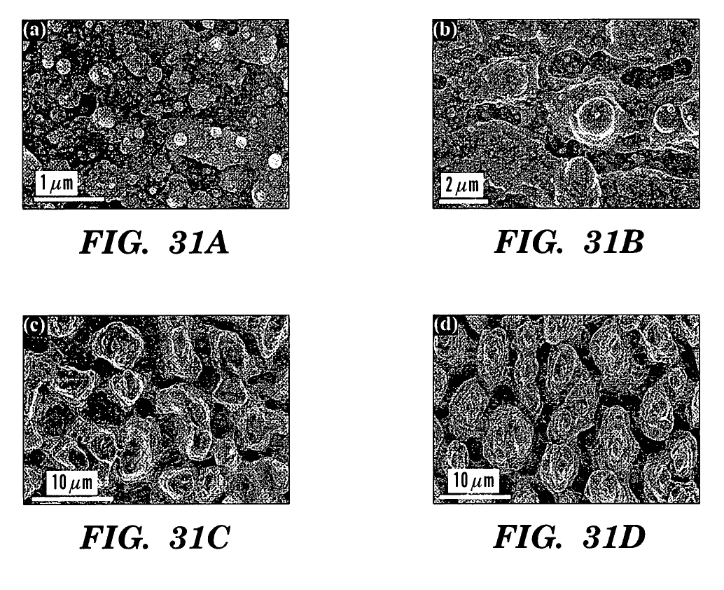

FIG. 31 provides SEM images showing the surface topography of Ti following fs laser treatment at F=0.35 J/cm² using the laser described in the legend to FIG. 26. (a) Nano and microroughness after 1 shot laser treatment. (b) Typical random microroughness covered with nanostructures after 40 shot treatment. (c) Typical columnar microstructures after 100 shot treatment. (d) Typical columnar microstructures after 200 shot treatment.

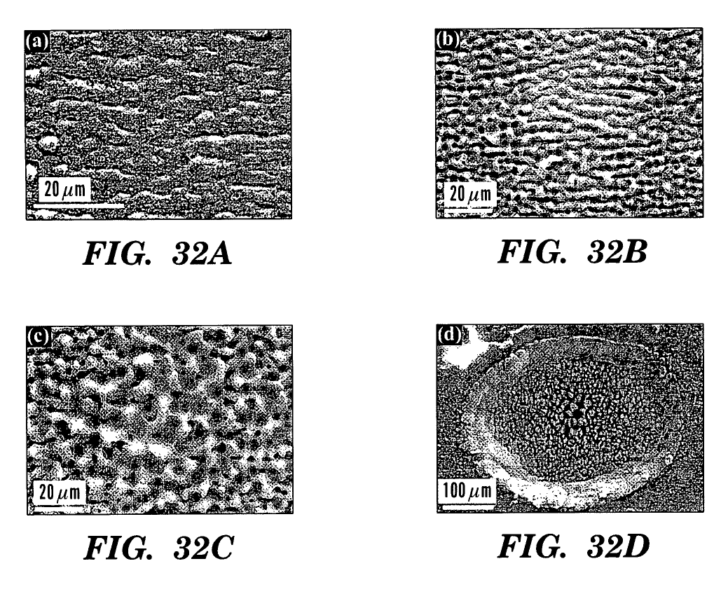

FIG. 32 provides SEM images showing the surface topography of Ti following fs laser treatment at F=0.48 J/cm² using the laser described in the legend to FIG. 26. (a) Microroughness covered with nanoroughness after 40 shots. (b) Typical microstructures following 70 shot treatment. (c) Typical microstructures following 100 shot treatment. (d) A crater with a diameter of about 350 um after a 1,500 shot treatment.

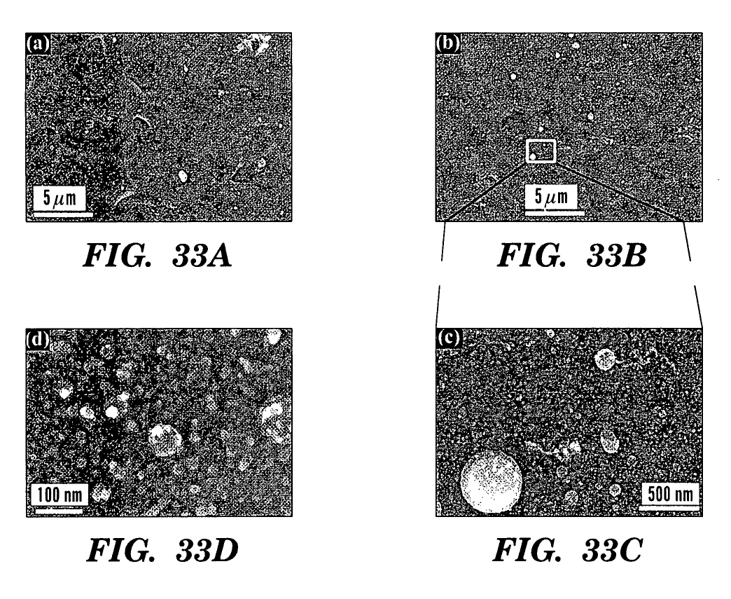

FIG. 33 provides SEM images showing the surface topography of Ti following fs laser treatment at F=2.9 J/cm² using the laser described in the legend to FIG. 26. (a) Smooth surface with microinhomogeneities after a 1 shot laser treatment. (b) Smooth surface with some nanostructures after 2 shots. (c) A magnified view of a section in (b) showing surface nanostructures. (d) Nanotopography of a smooth surface following 4 shot treatment with observable spherical nanostructures as small as about 10 nm.

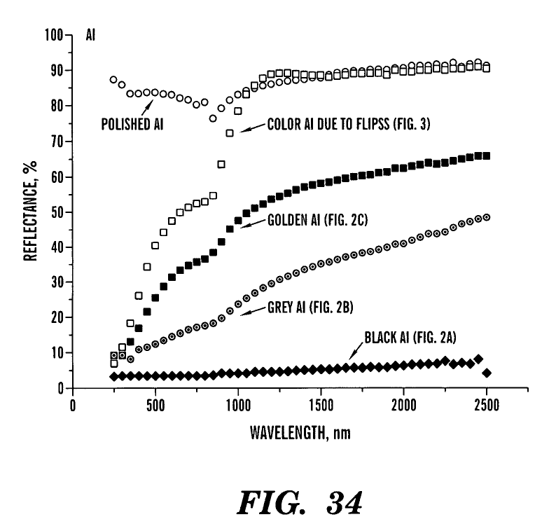

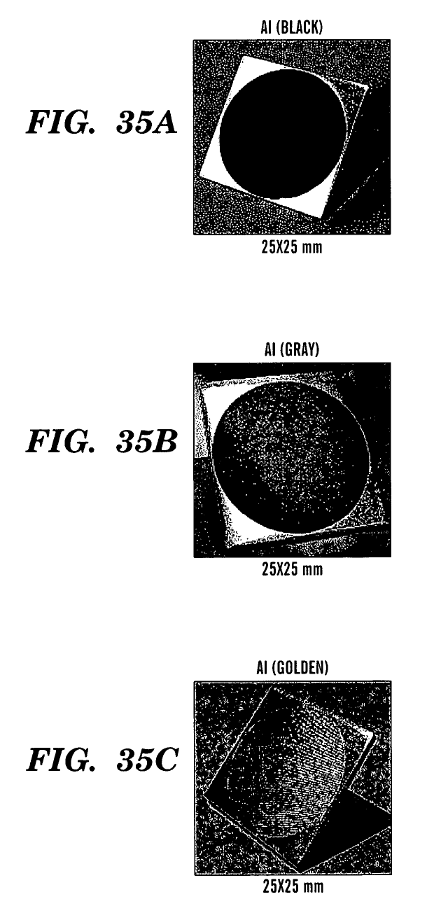

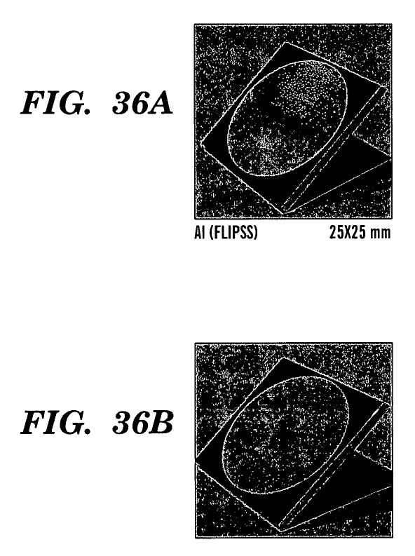

FIG. 34 provides a plot of % reflectance versus wavelength in nm for polished Al (open circles); “black” Al (black diamonds; see also FIG. 35(a)); grayed Al (gray circles; see also FIG. 35(b)); “golden” Al (gray squares; see also FIG. 35(c)); and, Al colored by FLIPSS (open squares; see also FIG. 36).

FIG. 35 provides photographs of metals processed to display different optical properties. (a) Black Al; (b) Grayed Al with two gray shades; (c) Golden Al. The spectral reflectances of these samples are provided in FIG. 34.

FIG. 36 provides photographs of Al colored by FLIPSS. The color of this sample depends upon the viewing angle due to a grating effect. The spectral reflectance of this sample at a near normal viewing angle is provided in FIG. 34.

### DETAILED DESCRIPTION OF THE INVENTION

### Detailed Description—Terminology

The present invention is generally directed to the materials processing regimes obtained with laser processing using ultra-short laser pulses of subpicosecond (i.e., up to hundreds of femtoseconds) duration, and to the altered materials obtained through such materials processing regimes.

Thus the present invention is based on the use of short and ultra-short duration laser beams to obtain novel material processing effects.

“Materials processing” as used herein refers to the “alteration” of materials, including, but not limited to: alterations such as removal of an entire portion of material (e.g., by making a hole in the material); alterations such as rearranging the structure (restructuring, e.g., by macro-, micro-, or nanostructuring) of a portion of the materials (e.g., by creating a sponge-like structure, a lattice structure, or other porous structure, examples of which are shown in the figures and are described in detail below); combinations of these materials processing regimes, etc.

Material alterations obtained in the present invention may be defined by a variety of experimental methods for analyzing the alterations obtained (synonymously “the materials processing outcome(s)”), for example by electron micrographic analysis, by spectroscopic analysis (e.g., absorption of light or other electromagnetic energy by the altered surface), etc. Material alterations may also be additionally and/or separately defined in terms of theoretical modeling of alterations and the mechanisms by which alterations are generated, e.g., by redeposition of material, the formation of laser induced periodic surface structures (LIPSS), etc.

In this regard the term “ablation” is used to refer to material alterations generally, rather than to any specific process of material alteration. Specifically, “ablation” is defined as occurring by experimental observation, i.e., by the onset of surface damage or alteration to the material being processed, where the surface damage or alteration is typically observed by eye or by SEM analysis. See, e.g., Example 2. Thus the term “ablation” is generic, and is not used to refer to a specific physical process of material alteration, for example the specific physical process of vaporization or other form of removal of material from a surface, etc.

The resulting changes to the materials being processed by materials processing are, generically, “alterations” to these materials, as discussed above. As described in more detail below, these alterations are further defined more precisely as, e.g., “macrostructures” (synonymously, “macroscale structure,” “macroscale roughness,” or “macroroughness”) such as craters, or other features obtained by macrostructuring. The alterations of the invention also include microstructures” (synonymously, “microscale structure,” “microscale roughness,” or “microroughness”) obtained by microstructuring, and “nanostructures” (synonymously, “nanoscale structure,” “nanoscale roughness,” or “nanoroughness”) obtained by nanostructuring. Whether a restructuring is macrostructuring, microstructuring, or nanostructuring depends on the dimensional scale of the alterations, e.g., alterations on a dimensional scale of microns occur for microstructures produced by microstructuring alterations, and alterations on a dimensional scale of nanometers occur for nanostructures produced by nanostructuring alterations.

A number of terms are used to further characterize the macrostructures, microstructures and nanostructures obtained by the laser pulse or pulse regimes of the present invention. With regard to microstructures, for example, “columnar microstructures” is used to refer to microstructures that appear visually under SEM analysis as columns. See, e.g., FIGS. 30 and 31. With regard to nanostructures, terms including “nanobranches,” “nanoparticles,” “nanoprotrusions,” “nanocavities,” “nanorims,” “nanopores” are used in the present invention to describe nanoscale dimension alterations resulting from the laser processing regimes of the invention having the visual appearances under SEM analysis of branches, particles, protrusions, cavities, etc. See, FIGS. 3, 6, and 26 for exemplars of these different micro- and nanostructures.

Further with regard to the above terms, SEM analysis may be used to establish quantitative as well as qualitative definitions for these macro-, micro-, and nanostructures, and these definitions may be used to define the materials obtained by the materials processing methods of the invention (for an example of a similar definition of a material produced by laser processing—albeit ps to millisecond (ms) processing—see, e.g., U.S. Pat. No. 5,473,138).

In some aspects of the invention it may be preferable to use a materials processing regime or regimes that creates essentially a single kind of materials structuring, while in other aspects it will be advantageous to create mixed structuring. In this context the word “dominated” is used herein to refer to a situation where one type of structuring is prevalent, i.e., where one type of structuring occurs across at least 80% of the surface area of the surface produced by the specified materials processing regime. In general, although 80% is defined as “dominating” (i.e., when the surface is “dominated” by nanostructures for example), it will be understood that other percentage values are explicitly contemplated, i.e., 70, 71, 72, 73, 74, 75 . . . 97, 98, 99% (i.e., counting by 1% intervals) of the surface area is of the structure specified.

Although the above visually-based terms are used to classify macrostructuring, microstructuring and nanostructuring occurring in the materials of the invention processed as detailed, other methods of categorizing these structures are explicitly contemplated. For example, because the absorptance of a material is a function of the intrinsic absorptance, A_{INTR}, and the surface roughness, A_{SR}, alterations to a material that manifest as alterations in surface roughness may be described by absorptance changes rather than, or in addition to, descriptions of macro-, micro-, or nanostructural change made based on changes in the visual appearance. Thus Example 1 below shows in detail how different fs duration laser processing regimes alter absorptance, and how these alterations in absorptance correlate with macro-, micro- and nanostructuring changes in the surface of the material.

Further with regard to absorptance, as shown in Example 1 and particularly in FIG. 1, the materials processing regimes of the present invention are capable of producing alterations to materials resulting in extremely high absorptivity, e.g., absorptivity for gold of close to 100%. Such high absorptivity may have particular utility in, e.g., heat absorption applications (e.g., heat exchange and heat absorption for hot water heating from solar energy, etc.). However, as FIG. 1 shows, other absorptances may also be obtained in the present invention, and these intermediate absorptances are also expected to have utility. Thus the present invention is directed to producing materials with absorptance of 0.01, 0.02, 0.03, 0.04, 0.05, . . . , 1.0 (counting by 0.01).

The absorptances determined in Example 1 are measured calorimetrically; however, absorptances may also be measured by other means, and specifically by methods that allow absorptance to be determined as a function of the wavelength of the light impinging on the sample. Reflectivity may also be measured in addition to, or in substitution for, absorptance, especially in situations where it is desirable to produce a material with favorably altered reflectivity. Reflectivity may be measured by any standard method used for such determinations; example of reflectivity measurements are provided in, for example, U.S. Pat. No. 4,972,061, the contents of which are incorporated herein by reference in their entirety.

Thus for example various aspects of the present invention are directed to materials for use in jewelry and to methods for making these materials. In these embodiments, the surfaces of metals such as gold, platinum, silver, stainless steel and similar precious metals, decorative metals, etc., are decorated, initialed, patterned or otherwise marked so as to have reduced reflectivity, with the reflectivity of the marked area or areas ranging from the reflectivity of the unmarked metal down to essentially 0% reflectivity, depending upon the desired application.

The materials to be altered by materials processing or, generically, ablation, include most generally metals, semiconductors, and dielectrics. Thus metals including, but not limited to, gold, aluminum, copper, platinum, titanium, alloys of these metals etc., are contemplated. Also contemplated are ceramics, glasses, plastics, etc. For a non-limiting example of plastics, see, U.S. Pat. No. 5,632,916, the contents of which are herein incorporated by reference in their entirety.

For the embodiments of the present invention directed to metals, both metal films (e.g., thin metal layers coated on glass, silicon or other additional underlying layer) and additionally bulk metals are contemplated. In this regard, a significant amount of research has been devoted to the materials processing of thin metal films, including materials processing by laser beam irradiation to, e.g., completely remove portions of the metal film from the underlying layer. See, e.g., U.S. Patent Publication No. 2006/0213880A1. While one embodiment of the present invention is directed to such materials processing including both thin film metal removal and thin film metal structuring (i.e., macro-, micro-, and nanostructuring of such thin films), the present invention is also directed to materials processing of “bulk” metals, i.e., non-thin films of more than a few hundred nm, preferably more than 1 um, and still more preferably more than 10 um in thickness. Thus “bulk metals” refers to metals with the characteristics just recited, whereas “thin films” refers to metals of less than a few hundred nm, including the thin films described in the Examples below.

Further with regard to the materials of the present invention, as shown in the Examples and in, e.g., FIGS. 13-14, there is evidence that various of the alterations of the materials obtained by materials processing occur preferentially on surface defects of the materials being irradiated by the laser beam of the present invention. Thus in some situations it will be preferable to use highly polished materials in order to reduce the preferential formation of material alterations at material defects; in other situations, it will be preferably to leave the material unpolished, to roughen the material, or even to introduce inhomogeneities or other “defects” into the material in order to facilitate certain alterations.

The methods of the present invention utilize lasers to accomplish the desired alterations to materials. As used herein, “short” duration laser pulses are laser pulses on the order of nanoseconds (ns) or picoseconds (ps), whereas “ultra-short” pulses are pulses of less than 1 ps, i.e., are pulses in the femtosecond (fs) range. Pulse duration is a function of the laser system used, with, e.g., a ruby laser producing 45 ns pulses at a wavelength of lambda=0.69 um, a Nd:YAG laser producing 55 ns pulses at a wavelength of lambda=1.06 um. In the present invention, the laser system is preferentially a Ti:sapphire laser system generating 65 fs duration pulses at a central wavelength of 0.8 um; however, other laser systems generating different pulse durations are also contemplated. See, e.g., U.S. Pat. No. 6,979,798 and U.S. Publication No. 2006/0207976A1, the contents of which are incorporated herein by reference in their entireties, for non-limiting descriptions of other such fs duration laser systems, e.g., a Yb-doped fiber laser such as the FPCA uJewel (available from IMRA America, Ann Arbor Mich.). Other such fs duration lasers contemplated include, e.g., dye lasers, Cr:LiSAF lasers, KrF lasers, etc.

In addition to laser pulse duration, a number of other laser parameters may be varied in various aspects of the present invention in order to obtain the desired materials processing effects, including but not limited to: the polarization of the laser beam (typically horizontally polarized); the diameter of the spot of laser irradiation on the surface of the material sample (typically between 100 and 1200 um); the wavelength of the laser beam; the energy density (fluence) of the laser beam; the number of laser pulses (shots) applied to the material sample; the extent of overlap between multiple laser pulses (shots) applied to the particular region of the material being processed; whether the shots are applied in vacuum or under higher pressure conditions; etc.

Thus with regard to the wavelength of the laser beam, the present invention preferentially uses a central wavelength (lambda) of 0.8 μm for the laser beam, i.e., a wavelength in the infrared. However, the present invention is explicitly not limited to laser radiation of this central wavelength, and includes other wavelengths in the visible, ultraviolet, infrared, THz frequency, etc.

With regard to the energy density or, synonymously, fluence (F) of the laser beam falling on the surface of the material to be processed, as will be discussed below, contemplated fluences are generally below about 25 J/cm² at the material surface, i.e., below about 25, 24, 23, 22, 21, 20, 19, 18, 17, 16, 15, 14, 13, 12, 11, 10, 9, 8, 7, 6, 5, 4, 3, 2, or J/cm². The exact choice of fluence varies, however, depending upon the desired materials processing effects desired. Thus for example the summary graphic of FIG. 19 shows that different materials properties may be obtained for fs laser irradiation using different combinations of laser fluence and number of laser pulses.

Further with regard to fluence, in one embodiment the choice of fluence is expressed by reference to the threshold laser fluence (synonymously, the “ablation threshold” or F_{abl}) required for visible material surface damage under SEM. Thus as described in the Examples, materials processing effects can be calibrated to the ablation threshold, e.g., the fluence specified to obtain a particular effect may be given both in absolute terms of J/cm², or, alternatively, may be given as a percentage of the ablation threshold, i.e., as 1, 2, 3, 4, 5, . . . 100, 101, 102, 103, 104, 105, . . . 10,000% (counting by ones) of F_{abl}.

With regard to laser pulses, the present invention uses both single- and multi-pulse exposures of materials to obtain the desired materials processing effects as discussed below. Laser “pulse” or synonymously “shot” refers to a single laser pulse applied to the sample material using for example an electromechanical shutter to select a single pulse or a train of pulses. Multi-pulse or multi-shot situations involve more than a single shot, e.g., 2, 3, 4, 5, 6, 7, 8, 9, 10, etc. (counting by ones) up to thousands or even tens-of-thousands or hundreds-of-thousands of shots. The exact number of pulses or shots chosen will depend upon the desired materials processing outcome, as shown in for example the summary graphic of FIG. 19 or as discussed elsewhere below.

The extent of overlap between shots in a multi-shot situation may be varied in order to obtained desired effects, e.g., by specifying that at least x % of the area of an additional shot or shots overlap with the first shot, where x can be 1 to 100% counting by ones (i.e., 1, 2, 3, 4, 5, . . . , 100%). Such variations may be particularly important in light of the observations presented elsewhere below that show that the portion of the material in the center of the irradiation by the laser pulse or pulses often undergoes different alterations as a result of the centrality of the beam than portions of the material at the periphery of the pulse or pulses. See, e.g., the data provided in FIGS. 18 and 22.

As a result of shot overlap or other procedures a variable percentage of a surface may be altered to have the desired structure or structures. For example, a precise scanning pattern of a laser beam across the surface of the material may be used to ensure that a variable percentage of the surface is altered to possess the desired nanostructure(s), microstructure(s), macrostructure(s), or combination thereof. Contemplated percentages of a surface to be modified range from 1 to 100% counting by ones (i.e., 1, 2, 3, 4, 5, . . . , 100%). As shown in FIG. 18, precise patterns of laser irradiation application, either at one fluence alone or in some cases in a combination of fluences (e.g., high fluence/low fluence) may influence the type of structuring of the material obtained. Thus FIG. 18 shows that a two shot high fluence regime at F=9.6 J/cm² on copper will produce a mixed materials processing result of a microstructured central area surrounded by a nanostructured periphery.

In addition to specifying the percentage of the surface to be modified, the materials processing effects of the present invention may also be expressed in terms of a total area modified, e.g., 0.1, 0.2, 0.3, 0.4, 0.5, . . . 10,000 cm² (counting by 0.1 cm² units). In this regard, because the present application is directed to materials processing regimes and the novel materials resulting from these regimes, it is particularly important that the materials processing methods of the invention be adequate to producing sufficiently large amounts of altered materials, where these amounts may be specified in terms of the total surface area of the materials that has been altered.

The exact surface area or range of surface areas required for any particular application of the present invention will depend upon the application; aesthetic applications such as jewelry, for example, will require relatively small amounts of altered material on the bracelet, ring, etc., that is to be marked to contain a pattern of altered materials bands, swirls, etc. By contrast, larger surface areas of altered materials will be required for other applications, i.e., formation of heat absorptive surfaces, while applications requiring nanostructured surfaces for catalysis or for implantation into the human body (i.e., dental implants or other situations where nanostructuring is advantageous for cellular growth and penetration into the implant material).

One aspect of the invention that may be particularly advantageous in terms of the ability to form large amounts of materials suitably altered by macro-, micro-, or nanostructures is the observation that the materials processing effects of the present invention may be obtained under ambient air conditions.

Thus with regard to the pressure conditions under which the material or materials are exposed to the laser beam, as discussed below the pressure conditions under which materials processing occurs affect, for example, both the threshold laser fluence (synonymously, the “ablation threshold” or F_{abl}) required for visible material surface damage under SEM and the plasma ignition threshold (Fₚₗ) as assayed by the onset of bright violet radiation from the laser-irradiated spot as measured either by a photomultiplier or an open-shutter camera. See, e.g., FIG. 12. Therefore, various embodiments of the present invention are directed to materials processing at: low-pressure conditions (e.g., below 5 torr), where for example related materials processing to produce “gold-black” is done (see below and, e.g., Appl. Optics 32 (1997) 1136-1144); vacuum conditions (i.e., below 0.1 torr); between 5 torr and 760 torr (1 atm), i.e., 5, 6, 7, 8, 9, 10, 760 torr (counting by ones); and, atmospheric pressure, where the Examples provided below show desirable materials processing effects can occur, contrary to a variety of literature which explicitly states that materials processing must be performed at low pressure (e.g., for laser pulses of ps to ns duration, U.S. Pat. No. 5,473,138, col. 3, lines 39-40, states that, “[f]or metal surfaces, the irradiation must occur under vacuum or at low pressure (less than 760 torr to prevent metal flow behavior and shock wave effects.”).

Additionally with regard to pressure conditions, Example 2 below discusses the effects of ambient air versus a highly reactive gas (oxygen) versus an inert gas (helium) on materials processing using ns duration pulses, and concludes that these effects are dependent upon gas pressure, rather than the type of gas environment used. While these effects are expected to be applicable to fs duration pulses as well, the present invention nevertheless contemplates the uses of purified gases in addition to ambient air for use with the materials processing regimes of the present invention. Specifically, since, e.g., inert gases in particular may have particular desirable effects, such gases or any other purified gas or mixture of gases may be used in the present invention.

### Detailed Description—Methods of the Invention

As discussed above, the present invention uses pulsed laser beams of femtosecond (fs) duration to obtain novel materials processing effects such as macrostructuring, microstructuring, and nanostructuring of materials, where the specific conditions required to generate a particular structure (macro-, micro-, or nano-) or combination of structures is a function of a number of variables as described above, including especially laser pulse duration, laser energy density or fluence (in J/cm²), and the number of pulses or “shots” of the laser beam delivered to a particular region of the material to be altered.

With regard to laser pulse duration, as is shown in the Examples below, both on theoretical and experimental grounds it is clear that ultra-short fs pulses can produce different materials processing effects than are seen in longer ps or ns “short” duration pulses. Thus previous studies regarding materials processing using ps or ns duration laser pulses (e.g., results such as those described in U.S. Pat. No. 5,635,089, 4,972,061, or 6,979,798 discussed in the Background of the Invention) are not generally applicable to the novel results obtainable with ps duration pulses, i.e., such ps or ns laser duration results do not adequately or accurately predict the results obtained for fs duration laser material processing.

Also shown in the Examples, it is equally clear that the materials processing effects obtained with fs laser pulses are not a priori uniform, and are instead highly dependent upon the specifics of these pulses, particularly upon the energy density or fluence of the laser beam and the number of pulses of the laser beam applied to the sample. Therefore, as shown in the Examples, and particularly in Example 1, considerable effort has been expended in the present invention in order to define combinations of fluence/shot number conditions that produce uniform materials processing results.

In this regard, as shown in, for example, FIG. 1, although the effects of fluence and number of shots of a fs laser beam on gold are nonuniform, with the appropriate amount of analysis as provided in, e.g., Example 1, these results can be categorized into four discrete regions of effect, specifically regions AB, BC, CD, and DE in FIG. 1. As the text of Example 1 makes clear, the different absorptances of the laser beam irradiated gold in various of these regions can be correlated with differences in the materials alterations achieved, i.e., region AB is associated with nanoscale roughness (see also FIG. 2); region BC is associated with nanoscale roughness including nanobranches (see FIG. 3(a)) and spherical nanoparticles (see FIG. 3(b)) and also contains microscale structures such as micropores, circular microgrooves, and central microchannels; and, region CD contains macroscale structures such as craters, periodic structures, etc. (see, e.g., FIG. 7).

As Example 3 shows, the regions defined in Example 1 and shown in FIG. 1 are applicable not just to the gold used to obtain the results in Example 1, but are instead relatively consistent across different materials. Thus Example 3 is directed to an analysis of the effects of fluence and shot number of a fs laser beam on copper, with the SEM results for various experiments shown in FIGS. 16-18 and 20. As the summary diagram for this data of FIG. 19 shows, there are essentially three regions defined by the data of Example 3: a region dominated by nanostructures (the X region in the figure); a region dominated by microstructures with some nanostructures (the open circle region in the figure); and, a region dominated by macrostructures with some micro- and nanostructures (the sold squares in the figure). These three regions are essentially equivalent to regions AB, BC, and CD (or possibly CD/DE) respectively of FIG. 1, and demonstrate that, although there would be no a priori ability to predict the existence of these regions, once the regions have been defined—as is the case in the present invention—the structures formed for each region are relatively predictable.

Further confirmation of the general applicability of the three regions of FIG. 19 to other materials, e.g., other metals, semiconductors, dielectrics, etc., is provided by the data of Example 5, where titanium metal was exposed to a varying number of fs duration laser pulses of varying fluence. Specifically, Example 5 shows that nanostructures are present with low laser fluences (see, e.g., FIGS. 26-29) as expected, and that for higher fluences of, e.g., 0.16 or 0.35 J/cm² and a sufficient number of laser shots (e.g., 20-200; see FIGS. 30 and 31), microstructuring occurs as predicted by the data of FIG. 19. Finally, again as predicted by the data of FIG. 19, for 1,500 shots at a fluence of 0.48 J/cm² macrostructures are formed as predicted (see, e.g., FIG. 32(d)).

### Detailed Description—Applications of the Present Invention Generally

As discussed above, the present invention is directed to laser based materials processing methods for producing the altered structuring of materials, including nanostructuring, microstructuring, or macrostructuring, and combinations of these structures. Thus the present invention includes embodiments such as the materials processing methods used to obtain the desired alterations to materials, as well as embodiments directed to the altered materials themselves.

The altered materials of the invention have utility in a variety of applications, including, but not limited to: aesthetic or marking applications such as the application of patterning to the surface of jewelry; medical applications, e.g., for medical devices to be implanted into an animal, where the novel properties of the laser altered surface of such a device aide in, for example, integration of cells of the animal into the implant; catalysis, where the properties of the altered materials and particularly the increased surface area of the materials resulting from, e.g., nanostructuring, improves the ability of the material to catalyze chemical reactions; heat transfer situations, where alterations resulting in increased absorptivity improve, e.g., the efficiency of solar cells and heat sinks; sensor sensitivity, where the unique alterations to materials described herein may be used in both a sensor's absorbing element to increase the amount of electromagnetic radiation absorbed and also in the shielding around the sensor or sensors to protect them from various forms of stray electromagnetic radiation, thereby helping to improve their signal-to-noise ratios; and, stealth technologies, or other technologies where the absorption of electromagnetic energy such as ultraviolet, visible, infrared, terahertz radiation, etc., cloaks or conceals or otherwise obscures the object coated or shielded with the altered material having the desired absorptive properties.

A number of these non-limiting applications are discussed in more detail below. This list is not intended to be comprehensive, and merely discloses some of the various embodiments of the present invention.

### Detailed Description—Aesthetic or Marking Applications of the Present Invention

In one aspect the present invention is directed to methods for materials processing that produce altered materials for aesthetic or marking applications, for example jewelry or other applications where the application of markings such as macro-, micro-, or nanostructures to materials may be performed to obtain desired aesthetic effects or for marking in general, i.e., for identification, etc.

Thus for example as the data of Example 1 show, fs based laser processing may be used to increase the absorptivity of a material, and such increased absorptivity will be observed visually as increased darkness or blackening of the region or regions of the material so altered. Thus using the laser methods of the invention markings may be made in metals or other materials, for example plastics or other materials, to obtain either aesthetic results or to obtain markings in general. In one embodiment the present invention is directed to such methods of obtaining these markings. In another aspect, the present invention is directed to the materials obtained by such alterations.

### Detailed Description—Biomedical Applications of the Present Invention

In another aspect the present invention is directed to methods for materials processing that produce materials suitable for biomedical applications, particularly medical applications where a metal or metal-clad device is to be implanted into an animal, and alterations to the metal or metal cladding can act to improve the biocompatibility of the metal or metal cladding.

Thus this aspect of the present invention materials including metals, ceramics, composites, etc., that are nanostructured and/or microstructured and then introduced or implanted into a biological milieu such as in bone, in tissue, etc., where biocompatibility is important for successful introduction or implantation. The materials contemplated include any as are known for introduction or implantation into the body, and include, but are not limited to, metals such as titanium, gold, silver, etc., alloys of these metals, composites, etc. The “biological milieu” may include bone, tissue, etc., of a whole organism, or of an isolated component of an organism, e.g., of an isolated organ, teeth, bones, etc. Organisms contemplated include animals, and particularly mammals, most preferably mammals such as humans.

Example 5 below discusses alterations to titanium metal using the fs laser methods of the present invention to alter the surface topography of titanium for better biocompatibility, i.e., to provide a surface containing, e.g., pits, pillars, steps, etc., or other structural features that serve as anchors or other attachment, scaffolding, or stimuli for protein and/or cellular integration.

“Biocompatibility” as used herein refers generally to alterations in the surface of a material that increase the ability of that material to integrate into the body, e.g., increase structural integration such as by invasion or interpenetration of the material by cells of the body or proteins or other biological material. Biocompatibility also refers to alterations that increase integration by decreasing rejection of the material by the body, as would occur if the material fails to integrate, i.e., so that the body recognizes the material as non-integrated and thus acts to encapsidate or otherwise reject it.

Biocompatibility may be assayed in a variety of ways. For implants, for example, biocompatibility may be determined by assaying the mechanical strength or stability of the integration of the implant into the body. Thus for example in osseointegration of dental implants, biocompatibility may be assayed by determining the force required to displace or separate out the implant from the surrounding bone. Biocompatibility may also be determined by directly observing (e.g., by SEM) the extent to which proteins, cells, or other biological materials are able to invade or integrate into the metal or other material altered by the materials processing methods of the present invention. As another non-limiting example of an assay for biocompatibility, methods for measuring cell death or proliferation may be used to determine the extent to which the altered surface topography of the material processed by the laser methods of the present invention results in the activation of cells to proliferate, or the active suppression of cell death mechanisms that would otherwise occur if the cells failed to find themselves in a suitable proliferative environment.

### Detailed Description—Catalysis Applications of the Present Invention

In another aspect the present invention is directed to methods for materials processing that produce materials with desirable catalytic properties, i.e., materials that contain sufficient macro-, micro-, or particularly nanostructural changes so as to have increased catalytic surface areas.

Such alterations may be assayed by SEM or other analyses that allow for the determination of the porosity or other increased surface area aspects of the materials altered. Alternatively, catalytic activity may be measured directly by determining the rate at which a reaction is catalyzed by an unaltered material (e.g., platinum) versus the rate of the reaction using an altered material.

### Detailed Description—Modifications of the Optical Properties of Materials

Another aspect of the present invention is directed to methods for altering the optical properties of materials, including, but not limited to, metals such as are provided in Example 6 below. Thus as shown in Example 6, the materials processing methods of the present invention may be used to obtain, e.g., metals which appear to the human observer to have various shades of gray (where “gray” may alternatively be defined as a material having relatively uniform reflectance across the entire visible wavelength), including multiple shades of gray in one metal piece. These materials processing methods may additionally be used to obtain what appear to the human observer to be colored materials (where “colored” may alternatively be defined as a material having preferential reflectance in some regions of the visible spectrum and not in others), e.g., colored metals such as are also described in Example 6. Although these methods are applied to metals in Example 6, the present invention explicitly contemplates the application of these methods for colored non-metal materials as well.

### EXAMPLE 1

### Example 1—Summary

In contrast to the common belief for femtosecond laser ablation that the thermal energy remaining in the ablated sample should be negligible, we recently found that a significant amount of residual thermal energy is deposited in metal samples following multi-shot femtosecond laser ablation. This suggests there might be a significant enhancement in laser light absorption following ablation. To understand the physical mechanisms of laser energy absorption, we perform a direct measurement of the change in absorptance of gold due to structural modification following multi-shot femtosecond laser ablation. We show that besides the known mechanisms of absorption increase via micro- and macro-structuring, there is also a significant absorption enhancement due to nanostructuring. It is found that nanostructuring alone can enhance the absorptance by a factor of about three. The physical mechanism of the total enhanced absorption is due to a combined effect of nano-, micro-, macro-structural surface modifications induced by femtosecond laser ablation. Virtually, at a sufficiently high fluence and with a large number of applied pulses, the absorptance of gold surface can reach a value close to 100%.

### Example 1—Introduction

Recently, much research activity has been focused on both physical processes of femtosecond laser ablation (D. Perez and L. J. Lewis, Phys. Rev. B 67, 184102 (2003); R. Stoian, A. Rosenfeld, D. Ashkenasi, I. V. Hertel, N. M. Bulgakova, and E. E. B. Campbell, Phys. Rev. Lett. 88, 097603 (2002); F. Vidal, T. W. Johnston, S. Laville, O. Barthelemy, M. Chaker, B. Le Drogoff, J. Margot, and M. Sabsabi, Phys. Rev. Lett., 86, 2573 (2001)) and its applications for high-precision materials micromachining (B. N. Chichkov, C. Momma, S. Nolte, F. von Alvensleben, and A. Tunnermann, Appl. Phys. A 63, 109 (1996)), thin-film deposition (G. Ausanio, A. C. Barone, V. Iannotti, L. Lanotte, S. Amoruso, R. Bruzzese, and M. Vitiello, Appl. Phys. Lett. 85, 4103 (2004)), generation of ultrashort x-ray pulses (M. M. Murnane, H. C. Kaypten, and R. W. Falcone, Phys. Rev. Lett. 62, 155 (1989)), and synthesis of nanoparticles (S. Eliezer, N. Eliaz, E. Grossman, D. Fisher, I. Gouzman, Z. Henis, S. Pecker, Y. Horovitz, M. Fraenkel, S. Maman, and Y. Lereah, Phys. Rev. B 69, 144119 (2004); S. Amoruso, G. Ausanio, R. Bruzzese, M. Vitello, and X. Wang, Phys. Rev. B 71, 033406 (2005); D. Scuderi, O. Albert, D. Moreau, P. P. Pronko, and J. Etchepare, Appl. Phys. Lett. 86, 071502 (2005)). It is commonly believed that one of the most important advantages of femtosecond laser ablation is that the energy deposited by ultrashort laser pulses does not have enough time to move into the bulk sample. Therefore, the residual thermal energy remaining in the bulk sample should be negligible. Recently, we performed a direct measurement on the thermal energy remaining in bulk metals following multi-pulse femtosecond laser ablation. In contrast to the previous belief, we found a significant amount of residual thermal energy deposited in various metals (A. Y. Vorobyev and Chunlei Guo, Appl. Phys. Lett. 86, 011916 (2005)). We suspect that an enhancement in absorption following femtosecond laser ablation is an important factor contributing to the enhanced residual thermal energy. However, it is unclear how femtosecond laser will induce such a noticeable change in absorption.

The absorptance A of a pure metal with a clean surface consists of two components A=A_{INTR}+A_{SR}, where A_{INTR} is the intrinsic absorptance and A_{SR} is the contribution due to surface roughness. (J. M. Elson and C. C. Sung, Appl. Opt. 21, 1496 (1982); M. Bass and L. Liou, J. Appl. Phys. 56, 184 (1984); A. M. Prokhorov, V. I. Konov, I. Ursu, and I. N. Mihailescu, Laser Heating of Metals (Adam Hilger, Bristol, 1990)) For an optically smooth metal surface, A_{SR} is about 1-2% of A_{INTR} but the role of A_{SR} enhances as the surface roughness increases. For multi-pulse ablation, only the first femtosecond laser pulse interacts with an undamaged surface, since the laser-induced surface structural modification develops long after the ultrashort pulse. In this case, A is governed by A_{INTR}, which can be a function of laser fluence due to laser-induced change in the dielectric constant of the material. All the subsequent laser pulses interact with a structurally modified surface and their absorption is determined by both A_{INTR} and A_{SR}. The absorption of a single femtosecond laser pulse by an undamaged metal surface has been studied in the past, where the absorption is dominated by A_{INTR}. (R. Fedosejevs, R. Ottmann, R. Sigel, G. Kühnle, S. Szatmari, and F. P. Schäfer, Phys. Rev. Lett. 64, 1250 (1990); A. Ng, P. Celliers, A. Forsman, R. M. More, Y. T. Lee, F. Perrot, M. W. C. Dharma-wardane, and G. A. Rinker, Phys. Rev. Lett. 72, 3351 (1994); D. F. Price, R. M. More, R. S. Walling, G. Guethlein, R. L. Shepherd, R. E. Stewart, and W. E. White, Phys. Rev. Lett. 75, 252 (1995); D. Fisher, M. Fraenkel, Z. Henis, E. Moshe, and S. Eliezer, Phys. Rev. E 65, 016409 (2001)) However, the coupling of laser energy to a metal in multi-pulse femtosecond laser ablation has not yet been investigated, where A_{SR} may have a significant value due to surface structural modification.

In this paper, we study the effect of surface structural modifications on the absorptance of gold in multi-pulse femtosecond laser ablation when an originally plane and smooth surface transforms into a blind hole. This effect is investigated as a function of the number of applied ablation pulses at various fluences. To study the absorptance, we apply a laser calorimetry technique (A. Y. Vorobyev and Chunlei Guo, Appl. Phys. Lett. 86, 011916 (2005); M. Bass and L. Liou, J. Appl. Phys. 56, 184 (1984)) that allows a direct measurement of laser energy absorbed by the sample. We show that femtosecond laser-induced surface modification enhances the sample absorptance that can reach a value close to 100% at a sufficiently high fluence with a large enough number of applied pulses. To understand the physical mechanism of this large enhancement in energy absorption, we also examine the surface modifications using a scanning electron microscope (SEM). We show that besides the known mechanisms of absorption increase via micro- and macro-structuring, there is also a significant absorption enhancement due to nanostructuring. It is found that nanostructuring alone can enhance the absorptance by a factor of about three.

### Example 1—Experimental Setup

In our experiment we use an amplified Ti:sapphire system generating 60-fs pulses of about 1.5 mJ/pulse at 1-kHz repetition rate and with a central wavelength at 800 nm. The laser beam is focused onto a sample with a 40-cm-focal-length lens at normal incidence. An electromechanical shutter is used to select the number of pulses, N, applied to the sample. The absorptance of the ablated spot is studied in the following way. After ablation of the sample with a chosen number of pulses, we reduce the laser fluence to a level much below the ablation threshold. Subsequently, we irradiate the ablated spot again using a train of low-fluence laser pulses that will not induce any further surface modification. A certain amount of energy from this low-fluence pulse train, E_{A}, is absorbed in the skin layer of the sample, dissipates via heat conduction in the sample, and causes its bulk temperature rise ΔT. We measure this temperature rise with a thermocouple battery that allows E_{A} to be determined calorimetrically as E_{A}=CΔT, where C is the known heat capacity of the sample. The details of this calorimetric technique have been described elsewhere. (A. Y. Vorobyev and Chunlei Guo, Appl. Phys. Lett. 86, 011916 (2005)) The measurement error for E_{A} is estimated to be about 10%. To measure energy E_{I} incident upon the sample, a certain fraction of incident pulse train energy is split off by a beam splitter and measured with a joulemeter. The measurement error of E_{I} is estimated to be about 5%. Having measured E_{I} and E_{A}, the absorptance of the ablated spot can be found as A=E_{A}/E_{I}. Laser-induced surface modifications are studied using a SEM and an optical microscope. The sample surface is mechanically polished.

### Example 1—Experimental Results and Discussion

The optical properties of surface modifications are studied following multi-pulse ablation at single-pulse laser fluences of F=1.1, 0.35, 0.17, and 0.078 J/cm² in air. The ablation threshold F_{abl} for a pristine surface is found to be F_{abl}=0.067 and 0.048 J/cm² for single-pulse and 500-pulse train irradiation, respectively. The numbers of pulses required to perforate a 1-mm-thick sample at the center of the irradiated spot are determined to be 16,100, 25,000, and 77,000 pulses at F=1.1, 0.35, and 0.17 J/cm², respectively. This corresponds to average ablation rates of 63, 40, and 13 nm/pulse, indicating that a single laser pulse produces a nanoscale modification in depth. Plots of absorptance versus the number of ablation shots, N, at different F are shown in FIG. 1. For an undamaged surface, we can see that the absorptance remains a constant value of 0.12 when measured at F=0.0043 J/cm², which is an order of magnitude below F_{abl}. The absorptance of a structurally modified surface is significantly greater than that of the undamaged surface and shows dependence on the number of applied ablation pulses, N.

The A(N) curves for the ablated surface can be characterized into four distinct regions marked with A, B, C, D, and E on A(N) in the case of F=0.17 J/cm² in FIG. 1. The first of these four regions is region (AB), where the absorptance initially increases from 0.12 (undamaged surface) to a value in the range of 0.25-0.33. Typically, this region covers the first 1-10 shots. For example, this initial enhancement of absorptance can be produced by four pulses at F=0.17 J/cm² or by one pulse at F=0.35 and 1.1 J/cm². Optical microscopy study shows that the irradiated spot is entirely covered with surface modification following ablation by only one pulse when F≧0.35 J/cm² but four pulses at F=0.17 J/cm². Therefore, the enhancement of A with N at F=0.17 J/cm² appears due to both the surface modification and an increase in size of the modified area from point A to B.

The second of these regions is region (BC), where absorptance undergoes a slight decrease as N increases. Typically, this region covers approximately the next 100-300 pulses. Both regions (AB) and (BC) extend to a larger number of pulses when the surface is modified at F only slightly above F_{abl}, as seen from the curve at F=0.078 J/cm² in FIG. 1.

The third of these regions is region (CD), which is characterized by a further enhancement of absorptance with the increase of N. This region extends to N of an order of 10,000 pulses.

Finally, the fourth of these regions is region (DE), where absorptance reaches the maximum value that does not change with further increase of N.

In order to understand how surface modifications affect absorptance, we take the SEM pictures of surface morphology shown in FIGS. 2-6. In (AB), (BC), and (CD) regions, where absorptance exhibits dependence on N, the following surface modifications are typically observed. For region (AB), a characteristic modification is nanoscale roughness (FIG. 2). In region (BC), two major features are observed. First, nanoscale roughness develops further in the form of nanobranches (FIG. 3 (a)) and spherical nanoparticles (FIG. 3 (b)). Secondly, microscale structures begin to develop in the forms of micropores, circular microgrooves, and central micro-channels. In region (CD), we start to observe features like a crater with a deep central micro-channel, periodic structures with orientation in the direction perpendicular to the laser light polarization and with a period roughly equal to the laser wavelength [FIG. 4(a)], and a visible black halo around the crater. All these laser-induced surface modifications can affect the absorptance in various ways. Surface roughness (M. Bass and L. Liou, J. Appl. Phys. 56, 184 (1984); L. K. Ang, Y. Y. Lau, R. M. Gilgenbach, and H. L. Spindler, Appl. Phys. Lett. 70, 696 (1997) can enhance the absorption of light both by multiple reflections in micro-cavities and by variation in the angle of incidence (angular dependence of Fresnel absorption). Nanoscale structural features can affect absorptance since the optical properties of a nanostructured material can be quite different from the bulk. (U. Kreibig and M. Vollmer, Optical Properties of Metal Clusters (Springer-Verlag, Berlin, 1995); C. G. Granqvist and O. Hunderi, Phys. Rev. B 16, 3513 (1977)) Laser-induced periodic surface structures (LIPSS) may enhance absorption of laser energy via generation of surface electromagnetic waves. (A. M. Prokhorov, V. I. Konov, I. Ursu, and I. N. Mihailescu, Laser Heating of Metals (Adam Hilger, Bristol, 1990); I. Ursu, I. N. Mihailescu, A. M. Prokhorov, V. I. Konov, and V. N. Tokarev, Physica 132C, 395 (1985)) It is worthy of mention that the LIPSS observed in our experiment has even finer nanoscale structural features shown in FIG. 4 (b).

Our study shows that the absorption of laser energy in femtosecond laser ablation can also be altered through re-deposition of ablated material. The examination of the black halo produced around the crater shows that its elemental composition determined by energy dispersive X-ray analysis is identical to that for a pristine surface, i.e. the black halo is a layer of the ablated and re-deposited gold. SEM images in FIGS. 5 and 6 demonstrate that the black halo has a structure of spherical nanoparticle aggregates that is typically seen in gold-black films. (W. Becker, R. Fettig, A. Gaymann, and W. Ruppel, Phys. Stat. Sol. (b) 194, 241 (1996); J. Lehman, E. Theocharous, G. Eppeldauer, and C. Pannell, Meas. Sci. Technol. 14, 916 (2003)) The gold-black films have been known for their high absorptance in the infrared. (D. J. Advena, V. T. Bly, and J. T. Cox, Appl. Optics, 32, 1136 (1993); W. Becker, R. Fetting, and W. Ruppel, Infrared Physics & Technology, 40, 431 (1999)) Therefore, the gold-black halo can enhance the absorption of low-intensity wings of the incident Gaussian beam and contribute to residual heating of the sample. Since re-deposition of ablated material occurs both outside and within the ablated spot, the re-deposition of the nanoparticles produced by ablation can also enhance the absorption of light in the ablated area. For example, an enhanced absorption of light by a semiconductor coated with Au nanoparticles has recently been reported. (D. M. Schaadt, B. Feng, and E. T. Yu, Appl. Phys. Lett. 86, 063106 (2005)) Therefore, in femtosecond laser ablation, the enhanced absorption can occur due to surface nano-, micro-, macro-structures and re-deposition of nanoparticles depending on ablation conditions. The combined effect of these surface modifications can lead to virtually 100% absorption of laser light in multi-pulse ablation with a sufficiently large number of pulses at high fluence as shown in FIG. 1. Previously (A. Y. Vorobyev and Chunlei Guo, Appl. Phys. Lett. 86, 011916 (2005)) we have also found that, under the same ablation conditions, almost all incident laser energy is retained in the sample as the residual thermal energy. This suggests that the energy carried away by the ablated material is small in Au, and the enhanced absorptance observed here appears to be the dominant factor in the enhanced residual thermal energy deposition observed previously (G. Ausanio, A. C. Barone, V. Iannotti, L. Lanotte, S. Amoruso, R. Bruzzese, and M. Vitiello, Appl. Phys. Lett. 85, 4103 (2004)) in multi-pulse femtosecond laser ablation at large numbers of applied pulses.

Since different surface modifications are superimposed on each other, it is difficult to completely isolate and determine each individual contribution to the enhanced absorptance. Therefore, we only provide the following estimations on the contributions of nano-, micro-, and macro-structures induced by femtosecond laser ablation. Since surface nano-structures are the dominant feature in region (AB) and part of region (BC) for N<50-100 and the absorptance increases from 0.12 to 0.25-0.33 over these regions (see FIG. 1), nano-structures alone account for the additional absorptance increase of about 0.1-0.2. The contribution of two microscale structures, LIPSS and random roughness, is estimated as follows. To estimated the contribution of LIPSS, we ablate a sample using p-polarized light and measure the low-fluence absorptance A(N) of the ablated spot with both p- and s-polarizations. The curves A(N) of different polarizations are found identical, and this indicates that the grating effects of microscale LIPSS on the absorption of laser light is negligible. To estimate the contribution of microscale random roughness, we abrade a mechanically polished sample surface with a sandpaper to produce a rms roughness of 3 μm, which is estimated to be comparable to the laser-induced roughness for 100<N<1000. The absorptance of this abraded surface is then measured to be about 0.24 as opposed to 0.12 for a mechanically polished surface, and this indirectly shows that the random micro-roughness accounts for the additional absorptance increase of about 0.12. Macro-structures come into play in two major forms, deep central channel and concentric ring grooves, when the number of pulses is roughly larger 500-1000 and laser fluence is higher than 0.17 J/cm². Two typical SEM pictures showing macro-structure craters are given in FIG. 7. The macro-scale crater formation starts in region (CD), and therefore, we believe the progressive increase of macro-structure size largely accounts for the absorptance increase from 0.4 to about 1.0. However, nano- and micro-structures also develop further in regions (CD) and (DE) and may also contribute to absorptance increase to some extent.

### Example 1—Conclusion

In summary, our study shows a significant increase in absorptance of gold due to surface modifications following multi-pulse femtosecond laser ablation. At sufficiently high fluence and with a large number of applied pulses, the absorptance can reach virtually 100%. We show that the physical mechanism of the enhanced absorption is due to a combined effect of nano-, micro-, macro-structural surface modifications induced by femtosecond laser ablation. Besides the physical mechanisms of the enhanced absorption discussed in this paper, our study also contributes to the fundamental understanding of femtosecond laser-matter interactions from the following aspects. First, laser-induced nanostructures alone can enhance the absorptance of Au by a factor of about three following only 1-3 pulses. This result suggests a new direction for future study of optical properties of nanostructures imprinted on a metal surface. Secondly, our study finds a new type of microscale periodic structure with much finer nanoscale structures following ablation with a large number of applied pulses. This observation may prompt us to reexamine our current understanding of the physical mechanism of periodic structure formation. Thirdly, re-deposition of laser-induced nanoparticles is also seen outside of the ablated spot leading to the formation of a nanostructured material known as gold black. Finally, our study also indicates potential applications of femtosecond laser ablation for modifying optical properties of metals and producing technologically valuable surface coatings such as gold-black films.

### EXAMPLE 2

### Example 2—Summary

In this Example, a comparative study of residual thermal effects in aluminum following fs- and also ns-duration laser ablation was performed. The results obtained show a surprisingly general trend in their behavior, despite many differences between ns and fs laser-matter interactions. At laser fluences above the ablation threshold where plasmas are produced and at a sufficiently high ambient gas pressure, an enhanced coupling of pulsed laser energy to the sample occurs. This effect appears to be a universal phenomenon for both ns- and fs-laser ablation in gas media. Furthermore, in contrast to the common belief that residual thermal energy is negligible in fs-laser ablation, our study shows that up to 70% of the incident pulse energy can be retained in the sample following single-pulse fs-laser ablation in 1-atm air. In both ns- and fs-laser ablation, the major factors governing thermal energy coupling to the sample are the laser fluence and ambient gas pressure. Residual thermal energy deposition decreases with reducing ambient gas pressure.

Thus these results show some surprising similarities between ns- and fs-duration laser pulse effects, where the effects are specifically those indicated in this Example.

### Example 2—Introduction

Laser ablation using nanosecond (ns) and femtosecond (fs) laser pulses has found numerous applications. These include materials processing and machining (D. Bäuerle: Laser Processing and Chemistry, 3rd edn. (Springer, Berlin, 2000), thin-film deposition (G. K. Hubler, D. B. Chrisey (Eds): Pulsed Laser Deposition of Thin Films (Wiley & Sons, New York, 1994)), laser microanalysis (R. E. Russo: Appl. Spectrosc. 49, A14 (1995)), and nanotechnology (D. B. Geohegan, A. A. Puretzky, G. Duscher, S. J. Pennycook: Appl. Phys. Lett. 72, 2987 (1999)). Comparative studies (B. N. Chichkov, C. Momma, S. Nolte, F. von Alvensleben, A. Tunnermann: Appl. Phys. A 63, 109 (1996); A. Semerok, C. Chaleard, V. Detaille, J.-L Lacour, P. Mauchin, P. Meynadier, C. Nouvellon, B. Salle, P. Palianov, M. Perdrix, G. Petite: Appl. Surf. Sci. 138-139, 311 (1999); R. Le Harzic, N. Huot, E. Audouard, C. Jonin, P. Laporte, S. Valette, A. Fraczkiewicz, R. Fortunier: Appl. Phys. Lett. 80, 3886 (2002); V. Margetic, A. Pakulev, A. Stockhaus, M. Bolshov, K. Niemax, R. Hergenröder: Specrochim. Acta Part B 55, 1771 (2000)) have demonstrated that femtosecond laser ablation has advantages over nanosecond ablation in aspects of higher precision, reduced heat-affected zone, and smaller amount of debris around the ablated spot. Following laser ablation, a fraction of absorbed laser energy is retained in the heat-affected zone, dissipates into the bulk of the sample and remains inside as residual thermal energy that induces the bulk temperature of the sample to rise. This is sometimes referred to as the thermal load and is often undesirable in laser micro- and nano-machining. In this paper, we perform a comparative study on the thermal energy remaining in Al following ns- and fs-laser ablation.

The coupling of thermal energy into metals has been previously studied for microsecond (S. Marcus, J. E. Lowder, D. L. Mooney: J. Appl. Phys. 47, 2966 (1976); W. E. Maher, R. B. Hall: J. Appl. Phys. 49, 2254 (1977); J. A. McKay, R. D. Bleach, D. J. Nagel, J. T. Schriemph, R. B. Hall, C. R. Pond, S. K. Manlief: J. Appl. Phys. 50, 3231 (1979)) and nanosecond (N. N. Golodenko, A. Y. Vorobyev, V. M. Kuzmichev, V. G. Guzhva: Radiotekhnika (Kharkov), No. 38, 138 (1976), in Russian; A. Y. Vorobyev, V. M. Kuzmichev: Sov. J. Quantum Electron. 10(1), 103 (1980) [Notice the printing error in the caption of FIG. 1 which should be read: Absorptivity K of a crater region on a copper target (∘ air; □ xenon; vacuum) and the fraction K₀ of the laser radiation energy retained in the target in air in the absence of a quartz plate (open triangles)] A. Y. Vorobyev: Sov. J. Quantum Electron. 15(4) 490 (1985)) laser ablation. An enhanced residual thermal energy coupling to metals has been observed when laser fluence is above a certain threshold value. It has been suggested that, in addition to the direct absorption of laser light, energy transfer from laser-produced plasma (S. Marcus, J. E. Lowder, D. L. Mooney: J. Appl. Phys. 47, 2966 (1976); W. E. Maher, R. B. Hall: J. Appl. Phys. 49, 2254 (1977); J. A. McKay, R. D. Bleach, D. J. Nagel, J. T. Schriemph, R. B. Hall, C. R. Pond, S. K. Manlief: J. Appl. Phys. 50, 3231 (1979)) can contribute to residual heating. However, mechanisms responsible for thermal coupling are still not fully understood.

More recently, we have observed an enhanced residual heating of metals following multi-pulse femtosecond laser ablation (A. Y. Vorobyev, C. Guo: Appl. Phys. Lett. 86, 011916 (2005)), where laser-induced surface modification has been found to play a role in enhanced residual heating but this alone could not fully account for the observed amount of deposited thermal energy. To exclude the effect of surface modification on residual thermal response, in this paper we extend our previous study of multi-pulse fs-laser ablation to single-pulse ablation. Furthermore, we also study residual thermal response of aluminum (Al) following ns-laser ablation and we compare the obtained results with those for fs-laser ablation. We use a calorimetric technique to study effects of laser pulse duration, ambient gas pressure, and laser wavelength on residual heating of Al. To characterize the residual thermal response, we define a so-called residual energy coefficient (REC) K=E_{R}/E_{I}, where E_{R} is the residual thermal energy remaining in the sample following ablation and E_{I} is the incident laser pulse energy. By definition, REC equals to absorptance of the sample material when laser fluence is below the ablation threshold. We show that enhanced residual heating occurs following both single-pulse ns- and single-pulse fs-laser ablation in ambient gas at a sufficiently high pressure and that the major factors governing the residual heating are laser fluence and ambient gas pressure. Note, we would like to emphasize there are several differences in this current study compared to our previous measurements ablation (A. Y. Vorobyev, C. Guo: Appl. Phys. Lett. 86, 011916 (2005)). Previously, the residual thermal effects are studied following multi-pulse femtosecond laser ablation, while this current work focuses on studying residual thermal effects following single-pulse ablation. There is a fundamental difference between multi-pulse versus single-pulse ablation because multi-pulse ablation may induce absorptance change due to accumulated surface modifications from multiple laser shots, while this accumulated effect does not occur in single-pulse ablation. Moreover, in this present paper, we will also study residual thermal effects following longer nano-second single-pulse ablation.

### Example 2—Experimental Setup

In this Example, both ns and fs duration pulse effects were examined. Thus the following three laser systems were used: 1) A ruby laser producing 45-ns pulses (FWHM) at wavelength λ=0.69 μm with pulse energy of 0.6 J; 2) A Nd:YAG laser generating 55-ns pulses at λ=1.06 μm with pulse energy of 1.4 J, and 3) A Ti:sapphire laser producing 60-fs pulses at λ=0.8 μm with pulse energy of 1.5 mJ. Using each laser system, the laser beam was focused onto an Al sample at normal incidence. A fraction of the incident pulse energy E_{I} was split off using a beamsplitter and measured with a joulemeter that allows E_{I} to be determined. The error associated with the measurement of E_{I} was estimated to be ±5%.

The residual energy E_{R} that remains in the sample following ablation causes the bulk temperature of the sample to rise by ΔT. Using a thermocouple attached to the Al sample, we measure ΔT after thermal equilibrium is reached in the sample. The details of this calorimetric technique have been described elsewhere ablation (A. Y. Vorobyev, C. Guo: Appl. Phys. Lett. 86, 011916 (2005)). Knowing the specific heat capacity cₚ and the mass m of the sample, the residual energy can be obtained from E_{R}=mcₚΔT. The thermocouple response time (the time required for achieving a maximum thermocouple signal in our calorimeter) is about 2.5 sec. We have also performed a series of tests on our calorimeter against possible external disturbance, such as electromagnetic interference effects on our calorimeter, and our calorimeter appears to be insensitive to external disturbance. The measurement error in E_{R} is estimated to be ±10%. Using measured E_{I} and E_{R}, the residual thermal energy coefficient K=E_{R}/E_{I} can be found as a function of single-pulse laser fluence F=E_{I}/S, where S is the laser beam area on the sample. The samples are mechanically polished. Measurements are performed in various ambient gases and at different pressures. The sample is translated with an X-Y stage so each subsequent laser pulse is incident onto a fresh spot. Two parameters are used throughout this paper, the ablation threshold F_{abl} and the plasma ignition threshold Fₚₗ. F_{abl} is determined as the onset of surface damage visible to eye with subsequent examination under scanning electron microscope (SEM). Fₚₗ is determined by observing the onset of bright violet radiation from the irradiated spot using either a photomultiplier (PMT) (P. P. Pronko, S. K. Dutta, D. Du, R. K. Singh: J. Appl. Phys. 78, 6233 (1995); W. E. Maher, D. B. Nichols, R. B. Hall: Appl. Phys. Lett. 37, 12 (1980); D. I. Rosen, J. Mitteldorf, G. Kothandaraman, A. N. Pirri, E. R. Pugh: J. Appl. Phys. 53, 3190 (1982)) or an open-shutter camera (W. E. Maher, R. B. Hall: J. Appl. Phys. 49, 2254 (1977)), both properly filtered to cut off scattered laser light.

### Example 2—Results and Discussion—Ns Duration Ablation

As already discussed, although the present invention is directed to fs-duration laser pulses, this Example probes some of the effects of both fs- and ns-duration laser pulses. Thus the dependence of REC for Al on laser fluence F following single-pulse ns-laser ablation in various ambient gases under different pressures are plotted in FIGS. 8 (for Nd:YAG laser) and 9 (for ruby laser). For Nd:YAG laser, ablation and plasma ignition thresholds in 1-atm air are determined to be F_{abl}=1.2±0.3 J/cm² and Fₚₗ=1.4±0.4 J/cm². For the ruby laser, these values are F_{abl}=1.0±0.2 J/cm² and Fₚₗ=1.1±0.3 J/cm². Thus, F_{abl}≈Fₚₗ in these experiments. By definition, REC should be equal to the absorptance of a certain material when it is irradiated by low-fluence laser light that does not cause any surface modification. Our measured value of REC (K=0.25) at F<F_{abl} in FIG. 2 agrees with the table value of absorptance for a mechanically polished Al sample at λ=1.06 μm (D. E. Gray (Ed.): American Institute of Physics Handbook, 3rd edn. (McGraw-Hill, New York, 1972)), and this agreement shows the accuracy of our measurement technique. Data at 1-atm in FIGS. 8 and 9 show that REC enhances abruptly at a certain fluence threshold, Fₑₙₕ, and reaches a maximum value of about 0.5-0.6 indicating that about 50-60% of the laser pulse energy can be retained in Al following nanosecond laser ablation. Our experiment also shows that Fₑₙₕ≈Fₚₗ within the experimental uncertainty for both Nd:YAG and ruby laser ablation. Next, we study the pressure effect on REC and representative curves are plotted in FIGS. 8 and 9. For Nd:YAG laser ablation, REC slightly decreases when air pressure, P, decreases from 1 atm to about 30 torr, but REC abruptly drops when pressure further reduces from 30 torr to about 0.6 torr. For P<0.6 torr, the onset of plasma is accompanied with a drop of REC. This drop becomes more pronounced as the pressure is further reduced to 0.04 torr. At this pressure, REC eventually reaches a value of about 0.12 that is smaller than the absorptance of an undamaged surface by a factor of two. For P<0.04 torr, REC virtually remains independent of the residual air pressure. This behavior shows that, in contrast to the observation in air, the onset of plasma in vacuum is accompanied with a drop of REC. In vacuum, both F_{abl} and Fₚₗ are higher than those at 1-atm air pressure by approximately a factor of two. Dependence of REC on laser fluence is also studied in 1-atm oxygen and 1-atm helium and these REC data are shown in FIGS. 8 and 9. The dependences show virtually the same behavior as those in air, indicating that REC does not essentially depend on the particular type of gas and thus, the contribution of possible exothermic chemical reactions that may occur due to presence of chemically active gases such as oxygen is negligible. Previously, the similar general behavior of REC has been seen in copper following ns-laser ablation using both ruby lasers (A. Y. Vorobyev: Sov. J. Quantum Electron. 15(4) 490 (1985)) and Nd:YAG lasers (N. N. Golodenko, A. Y. Vorobyev, V. M. Kuzmichev, V. G. Guzhva: Radiotekhnika (Kharkov), No. 38, 138 (1976), in Russian).

In vacuum, the laser plasma mainly consists of ionized species of ejected material. While in a gas medium, plasma consists of ionized species of both ablated material and ambient gas. A characteristic feature of ambient gas plasma produced by ns pulses is that the plasma expands due to the generation of laser-supported absorption waves (D. Bäuerle: Laser Processing and Chemistry, 3rd edn. (Springer, Berlin, 2000); M. von Allmen: Laser-Beam Interactions with Materials (Springer-Verlag, Heidelberg, 1987); L. J. Radziemski, D. A. Cremers (Eds): Laser-Induced Plasmas and Applications (Marcel Dekker, Inc., New York, 1989)). FIG. 10 shows open-shutter photographs of plasmas produced by 55-ns Nd:YAG laser pulses for ablation of Al in both air and vacuum under the same experimental conditions. Distinction between plasmas is clearly seen. The size of plasma in air is larger than that in vacuum. Therefore, the role of plasmas in residual heating of the sample in air may differ from that in vacuum.

The direct absorption of laser energy is a factor that may influence residual heating. According to the Drude model, when the temperature increases, material absorptivity should also increase due to an enhanced collision frequency between free electrons and thermally vibrating lattice atoms (M. Fox: Optical Properties of Solids (Oxford University Press, New York, 2001)). Therefore, one should expect an increase in REC with laser fluence due to this enhancement of material absorptivity. However, the fact that REC increases in air while decreases in vacuum above a certain laser fluence indicates that the temperature-enhanced Drude absorption does not play an essential role in enhanced residual thermal response. This is also confirmed by our estimation of the laser-induced surface temperature using the following formula (23 J. F. Ready: Effects of High-Power Laser Radiation (Academic Press, New York, 1971)):

$${T}_{S} ( t ) = \frac{A \sqrt{a}}{k \sqrt{π}} {\int }_{0}^{t} \frac{I ( t - θ )}{\sqrt{θ}} d θ + {T}_{0}$$

where A is the absorptance, a is the thermal diffusivity, I is the intensity of incident laser light, k is the thermal conductivity, t is the time, T₀ is the initial temperature, and θ is the integration variable. FIG. 11(a) shows the computed T_{S}(t) induced by the Nd:YAG laser pulse at F_{abl}≈Fₚₗ=1.4 J/cm² in 1-atm air and at F_{abl}≈Fₚₗ=2.7 J/cm² in vacuum with A=0.25, a=1.0×10⁻⁴ m²/s, k=240 J s⁻¹ m⁻¹° C.⁻¹, and T₀=20° C. We can see that the maximum surface temperature is about 500° C. in air and 1000° C. in vacuum. The estimated surface temperature in air is below both the melting (660° C.) and boiling (2495° C.) points of Al. The computed T_{S}(t) for ruby laser at F_{abl}≈Fₚₗ=1.1 J/cm² in 1-atm air and at F_{abl}≈Fₚₗ=2.1 J/cm² in vacuum with A=0.28 are shown in FIG. 11(b). Similar to the results of Nd:YAG laser in FIG. 5(a), the estimated surface temperature for ruby laser irradiation in air is also below both the melting and boiling points of Al. Thus, when the enhanced thermal coupling occurs in 1-atm air, the estimated surface temperature induced by both Nd:YAG and ruby lasers is too low to induce a significant increase in absorptance.

The similar general behavior of REC for Nd:YAG (λ=1.06 μm) and ruby (λ=0.69 μm) lasers shows that laser wavelength is relatively unimportant in the visible and near infrared spectral region. Nevertheless, our experiment clearly demonstrates that REC of aluminum sample depends mainly on laser fluence and ambient gas pressure following ns-laser ablation.

### Example 2—Results and Discussion—Fs Duration Ablation

As discussed above, although the present invention is directed to fs-duration laser pulses, this Example probes some of the effects of both fs- and ns-duration laser pulses. Thus the dependence of REC for Al on laser fluence F The dependences of REC on laser fluence for Al following fs-laser ablation in 1-atm air and in vacuum (P=0.01 torr) are plotted in FIG. 12. We can see that residual thermal energy coupling is enhanced in air above a certain threshold value of laser fluence, while in vacuum it is reduced. The values of F_{abl}, Fₚₗ, and Fₑₙₕ in air are found to be 0.053 J/cm², 0.086 J/cm², and 0.5 J/cm², respectively. These thresholds are well separated and the enhancement threshold is above the plasma threshold, i.e Fₑₙₕ≈Fₚₗ≈F_{abl}, in contrast to the ns-laser ablation where Fₑₙₕ≈Fₚₗ≈F_{abl}. We note that our measured value of Fₚₗ in 1-atm air agrees with that reported in Ref. [24] for Al thin film deposited on a silicon substrate. The values of F_{abl} and Fₚₗ in vacuum are determined to be 0.058 J/cm² and 0.096 J/cm², respectively (see FIG. 12). Contrary to the common belief that the residual thermal energy is negligible in an ablated sample following femtosecond laser ablation, our data show that REC reaches a value of 0.7 indicating that, at the highest laser fluence achievable in our experiment (F≈4 J/cm²), about 70% of the incident laser energy can be retained in the sample following single-pulse fs-laser ablation in 1-atm air. The behavior of REC in FIG. 12 also shows that laser fluence and ambient gas pressure have similar effects on REC in fs-laser ablation as those in ns-laser ablation.

To further understand fs laser-induced ablation, SEM images are taken for the sample studied. FIG. 13(a) shows an undamaged surface that is mechanically polished. A typical view of the sample surface after irradiation in air at F=F_{abl} is shown in FIG. 13(b). Note, FIG. 13(b) does not show the same spot on the sample as in FIG. 13(a). We can see from FIG. 13(b) that surface defects are preferential spots for initial ablation. We also noted some sparsely distributed small spherical nanoparticles in the irradiated area. FIG. 14 shows a typical laser-induced surface morphology following ablation at F=Fₚₗ in 1-atm air. It is seen that surface modifications are still localized around surface defects, but both the number and the size of nanoparticles are greater than those at F=F_{abl}. Therefore, material ejection in fs-laser ablation appears to be initiated at surface defects. Open-shutter photographs of the femtosecond laser-induced plumes taken at F=1.16 J/cm² (higher than Fₚₗ) are shown in FIG. 15. We can see that the size of the plume in air is larger than that in vacuum (P=0.01 torr).

There are three basic distinctions between ns- and fs-laser ablation. First, fs-laser pulses do not interact with ejected material because hydrodynamic expansion of ablated material from the irradiated area occurs on a timescale much longer than femtosecond pulse duration. Secondly, laser-supported absorption waves that are commonly generated in ns-laser ablation in a gas medium (D. Bäuerle: Laser Processing and Chemistry, 3rd edn. (Springer, Berlin, 2000); M. von Allmen: Laser-Beam Interactions with Materials (Springer-Verlag, Heidelberg, 1987); L. J. Radziemski, D. A. Cremers (Eds): Laser-Induced Plasmas and Applications (Marcel Dekker, Inc., New York, 1989)) do not exist in fs-laser ablation. Thirdly, a material irradiated with an intense fs-laser pulse can be heated to a solid-density plasma state. Despite these essential distinctions, our results show that residual thermal effects are surprisingly similar in ns- and fs-laser ablation and the enhanced thermal coupling to a metal appears to be a universal phenomenon in both ns- and fs-laser ablation in a gas medium.

Thus although the materials processing effects of the present invention that result from fs-duration laser pulses are not duplicated by ns-duration laser pulses, there are other effects that are similar for the two regimes.

### Example 2—Conclusion

In this Example, we have performed a systematic study of residual thermal response of Al following single-pulse ns- and fs-laser ablation. For laser fluence above the plasma threshold and at a sufficiently high ambient gas pressure, we observe an enhanced coupling of laser energy to Al sample using both ns- and fs-laser pulses. This effect appears to be a universal phenomenon in both ns and fs laser-matter interactions. Despite many differences between ns and fs laser-matter interactions, the general trend in residual thermal energy deposition is rather similar. In contrast to the previous belief that residual thermal energy is negligible following fs-laser ablation, our study demonstrates that about 70% of the incident fs-laser pulse energy can be retained in the sample following single-shot ablation in 1-atm air. Our study shows that the enhanced thermal coupling occurs not only in multi-pulse fs-laser ablation but in single-pulse fs-laser ablation as well. Both in ns- and fs-laser ablation, the most important factors affecting thermal energy coupling are laser fluence and ambient gas pressure. When the ambient gas pressure is reduced, residual thermal energy coefficient can decrease to below the absorptance of an undamaged surface. Laser ablation in vacuum appears to be advantageous to reduce residual thermal load by 3-4 times compared to that in air.

### EXAMPLE 3

### Example 3—Introduction

Unique properties of nanomaterials have been extensively studied in the past and various nanostructures have found numerous applications in optics (U. Kreibig and M. Vollmer, Optical Properties of Metal Clusters (Springer-Verlag, Berlin 1995)), optoelectronics (U. Kreibig and M. Vollmer, Optical Properties of Metal Clusters (Springer-Verlag, Berlin 1995)), enhanced x-ray emission (P. P. Rajeev, P. Ayyub, S. Bagchi, and G. R. Kumar, “Nanostructures, local fields, and enhanced absorption in intense light-matter interaction,” Opt. Lett. 29, 2662-2664 (2004). chemical catalysis (Nanostructured catalysts, S. L. Scott, C. M. Crudden, and C. W. Jones, eds. (Kluwer Academic, New York, 2003)), and optical biosensing (S. Chan, S. R. Horner, P. M. Fauchet, and B. L. Miller, “Identification of gram negative bacteria using nanoscale silicon microcavities,” J. Am. Chem. Soc. 123, 11797-11798 (2001)). For this reason, the development of new techniques for producing nanostructures is important for nanoscience and nanotechnology. Recently, femtosecond lasers have been demonstrated to be a promising tool for both producing nanostructures by deposition from plume of ablated material (S. Amoruso, G. Ausanio, R. Bruzzese, M. Vitello, and X. Wang, “Femtosecond laser pulse irradiation of solid targets as a general route to nanoparticle formation in a vacuum,” Phys. Rev. B 71, 033406 (2005); S. Eliezer, N. Eliaz, E. Grossman, D. Fisher, I. Gouzman, Z. Henis, Y. Horovitz, M. Frankel, S. Maman, and Y. Lereah, “Synthesis of nanoparticles with femtosecond laser pulses,” Phys. Rev. B 69, 144119 (2004)) and direct surface nanomachining of solids (S. Nolte, B. N. Chichkov, H. Welling, Y. Shani, K. Liebermann, and H. Terkel, “Nanostructuring with spatially localized femtosecond laser pulses,” Opt. Lett. 24, 914-916 (1999); J. Koch, F. Korte, T. Bauer, C. Fallnich, A. Ostendorf, and B. N. Chichkov, “Nanotexturing of gold films by femtosecond laser-induced melt dynamics,” Appl. Phys. A 81, 325-328 (2005); I. V. Hertel, R. Stoian, D. Ashkenasi, A. Rosenfeld, and E. E. B. Campbell, “On the physics of material processing with femtosecond lasers,” RIKEN Review No. 32: Focused on Laser Precision Microfabrication (LPM2000), 23-30 (January, 2001); A. P. Joglekar, H. Liu, E. Meyhöfer, G. Mourou, and A. J. Hunt, “Optics at critical density: Applications to nanomorphing,” PNAS, 101, 5856-5861 (2004)). For direct surface nanostructing, Nolte et al. have proposed a technique based on the use of a femtosecond laser in combination with a scanning near-field microscope. Koch et al. have reported an ablation-free technique suitable for femtosecond laser nanotexturing of metal thin films only. In contrast to the above-mentioned specific techniques for direct surface nanostructuring, we show in this paper that direct surface nanostructuring (not from the ablated plume deposition) is in fact a natural consequence of femtosecond laser ablation under certain experimental conditions. This type of surface nanostructures can be used in a number of technological applications, for example, manipulation of optical properties of solids [12], catalysts, dental implants, etc. However, a systematic study of the physical mechanism of the surface nanostructuring as well as the optimal conditions for a controllable nanostructuring using femtosecond laser ablation technique are lacking.

In this paper, we perform a detailed study of the morphology of surface nanomodifications produced on bulk metals using femtosecond laser ablation technique. The effects of laser fluence and number of applied pulses on the generated surface nanostructures are studied with a scanning electron microscope (SEM). We show, for the first time, that nanostructures are a natural consequence following femtosecond laser ablation of metals. We determine a set of optimal laser irradiation conditions for the surface nanostructuring and propose a mechanism for the formation of nanostructures

### Example 3—Experimental Setup

In our experiment, we use an amplified Ti:sapphire laser system that consists of a mode-locked oscillator and a two-stage amplifier including a regenerative amplifier and a two-pass power amplifier. The laser system produces 65-fs pulses with energy around 1 mJ/pulse at a 1-kHz repetition rate with a central wavelength λ=800 nm. The experimental setup follows that described in our previous works (A. Y. Vorobyev and C. Guo, “Enhanced absorptance of gold following multi-pulse femtosecond laser ablation,” Phys. Rev. B 72, 195422 (2005); A. Y. Vorobyev and C. Guo, “Direct observation of enhanced residual thermal energy coupling to solids in femtosecond laser ablation,” Appl. Phys. Lett. 86, 011916 (2005)). Briefly, to produce ablation, the laser beam is focused normally onto a bulk sample mounted vertically. To measure the incident pulse energy, a certain fraction of the incident light is split off by a beam splitter and measured with a pyroelectric joulemeter. The uncertainty of this measurement is estimated to be 5%. The number of laser shots, N, applied to the sample is controlled using an electromechanical shutter. All experiments are performed in air under atmospheric pressure. The morphology of femtosecond laser-induced surface modifications is studied using a SEM. The samples studied are mechanically polished copper, gold, and platinum. The range of laser fluence used in the ablation is between 0.084 and 9.6 J/cm². The number of applied pulses is varied from 1 to 5×10⁴ shots. The ablation threshold is determined as the minimum fluence to generate a surface damage seen under the SEM.

### Example 3—Results and Discussion

A SEM picture of the copper sample surface prior to laser irradiation is shown in FIG. 16(a). For a reference, the ablation threshold for a copper sample is determined to be F_{abl}=0.084 J/cm² following a total of N=100 shots. The morphology of the irradiated surface is studied following ablation with laser fluence of F=0.084, 0.16, 0.35, 1.52, 3.7, and 9.6 J/cm² and the number of applied pulses in the range of 1-5×10⁴. A number of representative surface structures produced on the copper sample are shown in FIGS. 16-18. An analysis of the SEM data obtained in our experiments shows that the morphology of femtosecond laser-induced surface nanostructures depends both on laser fluence and the number of applied pulses. The effect of the total shots on nanostructuring at F=0.35 and 1.52 J/cm² is shown in FIGS. 16 and 17, respectively. FIG. 16(b) shows that nanostructures begin to occur on some random localized sites after one shot at F=0.35 J/cm². A few larger-size structural features are also observed in the central part of the ablated area, as seen in FIG. 16(b). We believe that these larger structures are associated with surface defects and/or laser beam intensity inhomogeneities. FIG. 16(c) shows a nanoscale surface structure produced by two-shot ablation. The structure composes of both larger nanocavities and nanoprotrusions with spherical tips of a diameter up to about 75 nm. Therefore, the one additional shot transforms the sparsely distributed nanoscale features in FIG. 16(b) to cellular-like structures in FIG. 16(c). The surface morphology after ablation with 1000 pulses is shown in FIG. 16(d). One can see that the mean size of nanoprotrusions becomes larger while at the same time some nanocavities develop into microcavities. The evolution of the surface structures following ablation at F=1.52 J/cm² and various N is shown in FIG. 17(a-d). At this middle fluence, pure nanostructures are only generated by ablation with one or two laser shots [FIGS. 17(a) and 17(b)]. As shown in FIG. 17(c), ten-shot ablation produces both random nano- and micro-structures. With further increasing N, the proportion of nanostructures decreases and this can be seen in FIG. 17(d), where microscale structures become dominant. At the highest fluence used in our experiment, nanostructures are not present over most of the irradiated area and a dominant morphological feature is microroughness. However, nanostructuring can still be observed on the periphery of the ablated spot, where the Gaussian beam intensity is low enough for nanostructural formation. An example of these surface structural modifications are shown in FIG. 18 for two-shot ablation at F=9.6 J/cm².

The effect of laser fluence on surface structuring can be seen from analyzing the surface modifications produced at various F and fixed N, see, for example FIG. 16(c) (F=0.35 J/cm², N=2), FIG. 17(b) (F=1.52 J/cm², N=2), and FIG. 18 (F=9.6 J/cm², N=2). These images show that ablation with high laser fluence does not actually induce nanostructures and therefore there exist optimal laser ablation conditions for surface nanostructuring. In order to determine the optimal conditions for nanostructuring, we performed an SEM study of laser-induced surface modifications following ablation with a large variety of F and N, and the obtained data are summarized in FIG. 19. One can see that the most favorable conditions for pure nanostructuring are ablation at low and medium values of laser fluence (F<1.5 J/cm²). This ablation regime has been referred to as “gentle” ablation in studying dielectric materials in Ref. [10]. FIG. 19 also shows the range of laser irradiation parameters where femtosecond laser ablation produces different combinations of surface nano-, micro-, and macro-structures.

To determine the mechanism of nanostructuring, we further performed a careful SEM study on the origin of nanoscale modifications. A representative example of nascent nanostructures following ablation with F=0.35 J/cm² and N=1 is shown in FIG. 20(b), where the characteristic types of initial nanostructures are labeled. For comparison, FIG. 20(a) shows an undamaged area of the sample using the same scale as in FIG. 20(a). It is seen in FIG. 20(b) that surface structuring is initiated on random highly-localized nanoscale sites. The typical structures include circular nanopores with a diameter in the range of 40-100 nm, randomly-oriented nanoprotrusions with a diameter in the range of 20-70 nm and a length of 20-80 nm, nanocavities of arbitrary form, and nanorims around nanocavities. Therefore, under these femtosecond laser processing conditions, nanoscale features down to a size of 20 nm are produced. We can see from FIG. 20(b) that a nanopore or nanocavity is always immediately accompanied by a nanorim or nanoprotrusion, indicating a nanoscale material relocation to an adjacent site. This one-to-one nanoscale dips and protrusions occur randomly over the laser spot, suggesting an initial non-uniform laser energy deposition. Following are some possible factors responsible for the spatial variation of the absorbed laser energy: (1) the spatial inhomogeneity of the incident beam, (2) the enhancement of absorption by surface defects, (3) interference of the incident laser light with the excited surface electromagnetic waves due to structural defects. When the incident laser fluence is close to the laser ablation threshold, the spatial variations in deposited laser energy can produce a melt at localized nanoscale sites within the irradiated spot. Once the localized nanoscale melts have been formed, a high radial temperature gradient in a nanomelt can induce a radial surface tension gradient that expels the liquid to the periphery of the nanomelt (J. Koch, F. Korte, T. Bauer, C. Fallnich, A. Ostendorf, and B. N. Chichkov, “Nanotexturing of gold films by femtosecond laser-induced melt dynamics,” Appl. Phys. A 81, 325-328 (2005)). This will lead to the formation of nanocavities, nanoprotrusions, and nanorims due to fast freezing of the expelled liquid on the boundary with the solid state material (see FIG. 20(b)). This mechanism is also used to explain the formation of nanobumps on a thin metal film (J. Koch, F. Korte, T. Bauer, C. Fallnich, A. Ostendorf, and B. N. Chichkov, “Nanotexturing of gold films by femtosecond laser-induced melt dynamics,” Appl. Phys. A 81, 325-328 (2005)). These initially induced surface random nanostructures can enhance the absorption of laser light (A. Y. Vorobyev and C. Guo, “Enhanced absorptance of gold following multi-pulse femtosecond laser ablation,” Phys. Rev. B 72, 195422 (2005)) and facilitate the further growth of surface nanoroughness due to the increased spatial nonuniform energy absorption. When laser fluence is sufficiently high to produce ablation, the atoms ejected from the nanomelts produce a recoil pressure that squirts liquid metal outside of the nanomelt. For multi-pulse ablation, the repeating vaporization and re-deposition of nanoparticles back onto the surface should also affect the surface nanostructuring but the detailed mechanism requires further investigation. SEM morphology study at high fluence (F>5 J/cm²: strong ablation) shows that melt occurs over a large area of the ablated spot (see FIG. 18) and the flow dynamics in this large melt pool predominantly results in microstructuring. We have also performed studies on nanostructuring of gold and platinum, and nanostructures are observed on these metals as well indicating that nanostructuring is a natural consequence following femtosecond laser ablation of metals. In general, the size and the shape of nano-features on the three metals are similar. We have also studied the ambient gas pressure effect on nanostructuring by taking SEM images of platinum following single-pulse ablation in 1-atm air and in a vacuum at a base pressure of 8×10⁻³ Torr. Although we have observed a greater amount of re-deposited nanoparticles in air than in vacuum, the morphology of nanostructures is still quite similar under different air pressures. Our study was performed with samples mounted vertically. It should be noted that the amount of re-deposited ablated particles back onto the sample surface may be different when the sample is positioned vertically versus horizontally, but further studies are required in this aspect of nanostructuring using fs laser pulses.

### Example 3—Conclusions

In summary, we study the origin and formation of random surface nanostructures produced on metals using femtosecond laser ablation. We find that surface nanostructuring first occurs randomly on highly-localized nanoscale sites. Based on the morphology study with SEM, we believe that these nanostructures are formed due to the flow dynamics of a nanoscale melt that relocates material from the center of the melted site to the peripheral area resulting in a nanocavity, nanorim, or nanoprotrusions. A systematic study under a large variety of experimental conditions shows that the optimal conditions for pure nanostructuring are through femtosecond laser ablation at low and medium fluence with a certain number of pulses.

### EXAMPLE 4

### Example 4—Introduction

Laser-induced periodic surface structures (LIPSS) on solids have been studied in a number of works in the past. (M. Birnbaum, J. Appl. Phys. 36, 3688 (1965); D. C. Emmony, R. P. Howson, and L. J. Willis, Appl. Phys. Lett. 23, 598 (1973); M. Oron and G. Sorensen, Appl. Phys. Lett. 35, 782 (1979); Z. Guosheng, P. M. Fauchet, and A. E. Siegman, Phys. Rev. B 26, 5366 (1982); P. M. Fauchet and A. E. Siegman, Appl. Phys. Lett. 40, 824 (1982); J. E. Sipe, J. F. Young, J. F. Preston, and H. M. van Driel, Phys. Rev. B 27, 1141 (1983); J. E. Sipe, J. F. Young, J. F. Preston, H. M. van Driel, Phys. Rev. B 27, 1155 (1983); J. F. Young, J. E. Sipe, and H. M. van Driel, Phys. Rev. B 30, 2001 (1984); M. N. Libenson and A. G. Rumyantsev, Opt. Spektrosk. 60(4) 412 (1986); S. E. Clark and D. C. Emmony, Phys. Rev. B 40, 2031 (1989); A. M. Bonch-Bruevich, M. N. Libenson, V. S. Makin, and V. V. Trubaev, Opt. Eng. 31, 718 (1992)) Usually, LIPSS show regular groove structure with period on the incident laser wavelength scale and oriented perpendicularly to the polarization of the incident light. LIPSS are commonly seen following long pulse irradiation on a variety of materials, including semiconductors, metals, and dielectrics. Recently, the formation of LIPSS on semiconductors and dielectrics using femtosecond lasers has also been reported (J. Bonse, S. Baudach, J. Krüger, W. Kautek, M. Lenzner, Appl. Phys. A 74, 19 (2002); G. Dumitru, V. Romano, H. P. Weber, M. Sentis, W. Marine, Appl. Phys. A 74, 729 (2002); A. Borowiec and H. K. Haugen, Appl. Phys. Lett. 82, 4462 (2003); F. Costache, S. Kouteva-Arguirova, and J. Reif, Appl. Phys. A 79, 1429 (2004); J. Bonse, M. Munz, and H. Sturm, J. Appl. Phys. 97, 013538 (2005); T. Q. Jia, H. X. Chen, M. Huang, F. L. Zhao, J. R. Qiu, R. X. Li, Z. Z. Xu, X. K. He, J. Zhang, and H. Kuroda, Phys. Rev. B 72, 125429 (2005)), where LIPSS with a period either close to or smaller than the incident laser wavelength have been observed. However, very little work has been carried out for LIPSS on metals using femtosecond laser pulses. (J. Wang and C. Guo, Appl. Phys. Lett. 87, 251914 (2005)).

In contrast to the little previous work performed mostly at relatively high fluence, in this paper we carry out a detailed study of the formation of LIPSS on platinum and gold in a special fluence regime, namely, at near damage-threshold fluence. We find a unique type of LIPSS entirely covered with nanostructures. A distinctive feature of the nanostructure-covered LIPSS is that its period is appreciably less than that of the regular LIPSS whose period is approximately equal to the laser wavelength at normal incident laser light. We show that the reduced period of the nanostructure-covered LIPSS is caused by a significant increase of the real part of the effective refractive index of the air-metal interface when nanostructures develop on a metal surface that affects the propagation of excited surface plasmon polaritons. The nanostructure-covered LI PSS found in our study has a variety of potential applications, such as modifying optical properties of materials (A. Y. Vorobyev and C. Guo, Phys. Rev. B 72, 195422 (2005)) and chemical catalysts where high surface-to-volume ratio is a crucial factor.

### Example 4—Experimental Setup

In this experiment, we use an amplified Ti:sapphire laser system that generates 65-fs laser pulses with energy about 1 mJ/pulse at a 1-kHz repetition rate and with a central wavelength λ=0.8 μm. The horizontally-polarized laser beam is focused onto a vertically standing metal sample in air at normal incidence. The number of laser shots, N, applied to the sample is selected with an electromechanical shutter. We study the evolution of LIPSS on metals following irradiation with N=1, 2, 4, 8, 10, 20, 30, 40, 50, 100, 200, 300, 400, 500 pulses at near damage-threshold fluence. The studied metals are platinum and gold. The laser fluence of the incident light is varied by changing the distance between the focusing lens and sample. To measure the laser pulse energy incident upon the sample, a fraction of the incident laser beam is split off by a beamsplitter and diverted to a pyroelectric joulemeter. The morphology of the produced periodic structures is examined using a scanning electron microscope (SEM). The surface profile is measured with an atomic force microscope (AFM). All sample surfaces are mechanically polished using 0.1 μm grade aluminum oxide powder.

### Example 4—Results and Discussion

The evolution of surface structures produced on Pt following ablation at near damage-threshold laser fluence of F=0.16 J/cm² is shown in FIGS. 21(a)-(b). FIG. 21(a) demonstrates surface random nanoroughness produced after ten-shot ablation. The inset in FIG. 21(a) shows that this initial surface modification is characterized by nanocavities and nanoprotrusions of various forms. At N=20, a microscale periodic pattern starts to form over the initially produced random nanoroughness. At this stage, only small patches of periodical structures are observed in various isolated locations within the irradiated spot, and we will refer these as intermediate LIPSS below. With increasing N, the intermediate LIPSS grow and coalesce into a clear extended LIPSS with a period of 0.61 μm at N=30 [FIG. 21(b)]. For N greater than 70 shots, LIPSS starts to disappear gradually in the central spot area [FIGS. 22(a) and 22(b)]. However, clear nanostructured LIPSS continues to form in the peripheral area [FIGS. 22(c) and 22(d)]. Using AFM, the initial undamaged surface rms roughness is found to be about 5.6 nm after polishing, and a typical AFM surface profile measurement on Pt is shown in FIG. 23(a). Following ablation with N=1, 2, and 10 shots, surface rms roughness is found to be about 16.5, 35.2, and 79.8 nm, respectively. FIG. 23(b) shows typical surface roughness after N=10 shots. The surface profile of LIPSS after 30 laser shots is shown in FIG. 24. To gain the insight of how initial nanoroughness affects the formation of nanostructured LIPSS, we perform a SEM study of the formation of nanostructured LIPSS with samples of different initial surface conditions. We find that the extended LIPSS is produced with a smaller number of laser shots when the sample has a greater surface nanoroughness. To understand the material dependency in forming the nanostructure-covered LIPSS, we also perform a detailed SEM study of surface structural modifications on Au. Our data show that the general trend is similar for Au and Pt in forming the initial nanorougheness. The period of nanostructure-covered LIPSS on Au is observed to be 0.58 μm and is also markedly less than our laser wavelength (FIG. 25). However, the periodic patterns on Au are much less clear compared to Pt. Recently, we performed a comparison study on regular LI PSS on various metals following femtosecond laser radiation, (J. Wang and C. Guo, Appl. Phys. Lett. 87, 251914 (2005), where LIPSS shows distinctly different level of morphological clearness among various metals even under identical experimental conditions. The electron-phonon energy coupling coefficient, g, is shown to directly correlate to the morphological clearness of LIPSS. A larger g coefficient usually leads to more pronounced LIPSS. In this study, g coefficient for Pt and Au are 25×10¹⁶ and 2.1×10¹⁶ W/m³K, respectively, (J. Hohlfeld, S. S. Wellershoff, J. Gudde, U. Conrad, V. Jahnke, and E. Matthias, Chem. Phys. 251, 237 (2000)) and the much larger g coefficient explains why LIPSS is much more clear on Pt than Au.

The formation of LIPSSs at near damage-threshold fluence using femtosecond pulses has been rarely studied in the past. For longer nanosecond pulses, the fluence regime when LIPSS is formed at near damage-threshold is classified as the regime A. (J. F. Young, J. E. Sipe, and H. M. van Driel, Phys. Rev. B 30, 2001 (1984)) Our study shows that the periodic patterns induced by femtosecond pulses in this regime are distinctly different from those produced by longer pulses in two aspects. First, we observe that femtosecond laser-induced periodic structures are covered by random nanostructures. Secondly, the LIPSS period induced by femtosecond pulses at normal incidence is appreciably less than the laser wavelength while the period is roughly equal to the wavelength for longer pulses. To account for our observation, we carefully examine the evolution of surface structural modifications on both Pt and Au, and we propose the following mechanism for the formation of nanostructure-covered LIPSS. In our experiment, the first few laser shots usually produce sparsely and randomly distributed nanostructures. It is known that surface plasmons, both localized and propagating along a surface, can be excited by coupling laser energy into nanostructures. With further increase of the number of laser shots, more nanostructures appear allowing excitation of more localized and propagating surface plasmons. The produced nanoroughness includes nanorods, nanocones, and nanospheres, and these nanostructures will excite propagating cylindrical surface plasmons (M. N. Libenson and A. G. Rumyantsev, Opt. Spektrosk. 60(4) 412 (1986); A. M. Bonch-Bruevich, M. N. Libenson, V. S. Makin, and V. V. Trubaev, Opt. Eng. 31, 718 (1992)) that subsequently interfere with the incident light. This interference causes the formation of intermediate periodic surface microstructures. As the number of laser shots increases, the intermediate microstructures will grow as well as the area occupied by these structures. The developed intermediate periodic surface microstructures will further excite propagating plane surface plasmons that interfere with the plane incident laser light wave, and this interference will finally result in the permanent extended periodic microstructures.

For normally incident linearly polarized light, the period d of the surface grating formed due to the interference between the incident laser light and the excited surface plasmon wave is given by equation 1 (A. M. Bonch-Bruevich, M. N. Libenson, V. S. Makin, and V. V. Trubaev, Opt. Eng. 31, 718 (1992)) d=λ/η with g∥E, where λ is the incident light wavelength, η=Re[ε/(ε+1)]^{1/2} is the real part of the effective refractive index of the air-metal interface for surface plasmons, ε is the dielectric constant of the metal, g is the grating vector, and E is the electrical field vector of the incident wave. For a plane vacuum-metal interface, η is calculated to be 1.0096 at λ=800 nm for Pt (ε₁=−15.5 and ε₂=23.5) and 1.022 for Au (ε₁=−23.4, ε₂=1.55). (M. A. Ordal, L. L. Long, R. J. Bell, S. E. Bell, R. R. Bell, L. W. Alexander, and C. A. Ward, Appl. Opt. 22, 1099 (1983)) Using Eq. (1), the grating period is found to be 0.79 μm for Pt and 0.78 μm for Au. However, our data show that the observed period is 0.61 μm for Pt [FIG. 1 (b)] and 0.58 μm for Au [FIG. 5]. If we substitute these values of the observed period into Eq. (1), we will have η=1.31 for Pt and η=1.38 for Au. To explain this discrepancy, we note that the table values of ε₁ and ε₂ for Pt and Au are obtained from smooth surface and at room temperature, and therefore these values may not be suitable when the metals are heated by high-intensity femtosecond pulses and covered with nano- and micro-structures. To understand the high-intensity effects on LIPSS period, we perform a detailed study of LIPSS in various locations within the damaged spots on metals. From these data summarized in Table 1, we can see that the LIPSS period remains the same in the central and peripheral areas of an irradiated spot despite that the two locations have different intensities due to the Gaussian beam profile. On the other hand, the period of our nanostructure-covered LIPSS decreases with increasing N when the surface roughness grows while the light intensity remains constant. Furthermore, our study shows that the nanostructure-covered LIPSS produced using a higher fluence of 0.16 J/cm² exhibit a similar period as that produced at F=0.084 J/cm². The above-mentioned observations indicate that the high-intensity effect on dielectric constant is not essential in our experiment, whereas the effects of surface morphology (nano- and micro-roughness) are more dominant. It is in fact not difficult to understand why surface roughness plays a dominant role in our observation. It is known that surface roughness causes an increase in the modulus of the surface plasmon wave vector (E. Kroger and E. Kretschmann, Phys. Status Solidi, 76, 515 (1976), and this will correspond to an increase in the real part of the refractive index. According to Eq. (1), an increased real part of the refractive index for propagating surface plasmons will cause a reduced LIPSS period, and this agrees with our experimental observation.

TABLE 1
Nanostructure-covered LIPSS period in different areas of the irradiated
spot on platinum at F = 0.084 J/cm².

| LIPSS period (μm) | | |
|---|---|---|
| Number of shots | Central area | Peripheral area |
| 30 | 0.62 | 0.61 |
| 50 | 0.58 | 0.61 |
| 100 | 0.57 | 0.57 |
| 200 | 0.55 | 0.54 |
| 500 | 0.55 | 0.53 |

Finally, we note that under certain conditions, we can also produce a large number of nanoprotrusions and nanocavities on a metal surface (see FIG. 22). Therefore, the nanostructures produced can greatly increase the effective surface area that may be of importance in many technological applications, such as producing better chemical catalysts where a high surface-to-volume ratio is a crucial factor.

### Example 4—Conclusions

We have performed a detailed study of surface structural modifications following ablation of platinum and gold at near damage-threshold fluence. We find a unique type of LIPSS entirely covered with nanostructures. A distinctive feature of the nanostructure-covered LIPSS is that the period is appreciably less than that of the regular LIPSS. We show that the reduced period is caused by an increase of the real part of the effective refractive index of the air-metal interface when nanostructures develop and affect the propagation of surface plasmons.

### EXAMPLE 5

### Example 5—Summary

In this study we perform the first femtosecond laser surface treatment of titanium in order to determine the potential of this technology for surface structuring of titanium implants. We find that the femtosecond laser produces a large variety of nanostructures (nanopores, nanoprotrusions) with a size down to 20 nm, multiple parallel grooved surface patterns with a period on the sub-micron level, microroughness in the range of 1-15 μm with various configurations, smooth surface with smooth micro-inhomogeneities, and smooth surface with sphere-like nanostructures down to 10 nm. Also, we have determined the optimal conditions for producing these surface structural modifications. Femtosecond laser treatment can produce a richer variety of surface structures on titanium for implants and other biomedical applications than long-pulse laser treatments.

### Example 5—Introduction

Due to good biostability, biocompatibility, mechanical performance, and long-term durability, titanium has been widely used in a variety of biomedical applications such as dental and orthopedic implants, implantable electronic devices (D. M. Brunette, P. Tengvall, M. Textor, P. Thomsen, Titanium in Medicine: Material Science, Surface Science, Engineering, Biological Responses and Medical Applications, Springer, Berlin, 2001; N. Sykaras, A. M. Iacopino, V. A. Marker, R. G. Triplett, R. D. Woody, Int. J. Oral Maxillofacial Implants 15 (2000) 675; F. H. Jones, Surf. Sci. Rep. 42 (2001) 75). In numerous in vitro and in vivo studies, surface topography of titanium implants has been shown to be important in enhancing of implant performance (D. M. Brunette, P. Tengvall, M. Textor, P. Thomsen, Titanium in Medicine: Material Science, Surface Science, Engineering, Biological Responses and Medical Applications, Springer, Berlin, 2001; N. Sykaras, A. M. Iacopino, V. A. Marker, R. G. Triplett, R. D. Woody, Int. J. Oral Maxillofacial Implants 15 (2000) 675; F. H. Jones, Surf. Sci. Rep. 42 (2001) 75; J. E. Davies, Int. J. Prosthodont. 11 (1998) 391; R. G. Flemming, C. J. Murphy, G. A. Abrams, S. L. Goodman, P. F. Nealy, Biomaterials 20 (1999) 573). It has been shown that both microstructures (D. M. Brunette, P. Tengvall, M. Textor, P. Thomsen, Titanium in Medicine: Material Science, Surface Science, Engineering, Biological Responses and Medical Applications, Springer, Berlin, 2001; N. Sykaras, A. M. Iacopino, V. A. Marker, R. G. Triplett, R. D. Woody, Int. J. Oral Maxillofacial Implants 15 (2000) 675; R. G. Flemming, C. J. Murphy, G. A. Abrams, S. L. Goodman, P. F. Nealy, Biomaterials 20 (1999) 573); B. Kasemo, J. Gold, Adv. Dent. Res. 13 (1999) 8; K. T. Bowers, J. C. Keller, B. A. Randolph, D. G. Wick, Int. J. Oral Maxillofacial Implants 7 (1992) 302; E. T. den Braber, J. E. de Ruijter, L. A. Ginsel, A. F. von Recum, J. A. Jansen, Biomaterials 17 (1996) 2037; D. D. Boyan, T. W. Hummert, D. D. Dean, Z. Schwartz, Biomaterials 17 (1996) 137; F. Pfeiffer, B. Herzog, D. Kern, L. Scheideler, J. Geis-Gerstorfer, H. Wolburg, Microelectronic Engineering 67-68 (2003) 913) and nanostructures (D. M. Brunette, P. Tengvall, M. Textor, P. Thomsen, Titanium in Medicine: Material Science, Surface Science, Engineering, Biological Responses and Medical Applications, Springer, Berlin, 2001; R. G. Flemming, C. J. Murphy, G. A. Abrams, S. L. Goodman, P. F. Nealy, Biomaterials 20 (1999) 573); B. Kasemo, J. Gold, Adv. Dent. Res. 13 (1999) 8; A. S. G. Curtis, C. D. W. Wilkinson, J. Biomater. Sci. Polymer Edn. 9 (1998) 1313; A. S. G. Curtis, B. Casey, J. O. Gallagher, D. Pasqui, M. A. Wood, C. D. W. Wilkinson, Biophys. Chem. 94 (2001) 275) influence biological processes at implant interfaces. Various methods of implant surface structuring have been studied in the past such as grit-blasting (K. T. Bowers, J. C. Keller, B. A. Randolph, D. G. Wick, Int. J. Oral Maxillofacial Implants 7 (1992) 302; A. Wennerberg, T. Albrektsson, C. Johansson, B. Andersson, Biomaterials 17 (1996) 15; D. L. Cochran, J. Simpson, H. P. Weber, D. Buser, Int. J. Oral Maxillofacial Implants 9 (1994) 289; M. Taborelli, M. Jobin, P. Francois, P. Vaudaux, M. Tonetti, S. Schmukler-Moncler, J. P. Simpson, P. Descourts, Clin. Or. Implants Res. 8 (1997) 208; G. Cordioli, Z. Majzoub, A. Piatelli, A. Scarano, Int. J. Oral Maxillofacial Implants 15 (2000) (668); R. V. Bathomarco, G. Solorzano, C. N. Elias, R. Prioli, Appl. Surf. Sci. 233 (2004) 29), chemical etching (K. T. Bowers, J. C. Keller, B. A. Randolph, D. G. Wick, Int. J. Oral Maxillofacial Implants 7 (1992) 302; M. Taborelli, M. Jobin, P. Francois, P. Vaudaux, M. Tonetti, S. Schmukler-Moncler, J. P. Simpson, P. Descourts, Clin. Or. Implants Res. 8 (1997) 208; G. Cordioli, Z. Majzoub, A. Piatelli, A. Scarano, Int. J. Oral Maxillofacial Implants 15 (2000) (668); R. V. Bathomarco, G. Solorzano, C. N. Elias, R. Prioli, Appl. Surf. Sci. 233 (2004) 29; P. R. Klokkevold, R. D. Nishimura, M. Adachi, A. Caputo, Clin. Oral Implant Res. 8 (1997) 442; P. S. Vanzillotta, M. S. Sader, I. N. Bastos, G. A. Soares, Dental Materials 22 (2006) 275), titanium plasma-spray (M. Taborelli, M. Jobin, P. Francois, P. Vaudaux, M. Tonetti, S. Schmukler-Moncler, J. P. Simpson, P. Descourts, Clin. Or. Implants Res. 8 (1997) 208; G. Cordioli, Z. Majzoub, A. Piatelli, A. Scarano, Int. J. Oral Maxillofacial Implants 15 (2000) (668); A. Gaggl, G. Schultes, W. D. Müller, H. Kärcher, Biomaterials 21 (2000) 1067, laser treatment (A. Gaggl, G. Schultes, W. D. Müller, H. Kärcher, Biomaterials 21 (2000) 1067; J. L. Ricci, H. Alexander, Key Engineering Materials 198-199 (2001) 179; R. Stangl, B. Rinne, S. Kastl, C. Hendrich, European Cells and Materials 2 (2001) 1; A. Joób-Fancsaly, T. Divinyi, A. Fazekas, Cs. Daroczi, A. Karacs, G. Petõ, Smart Mater. Struct. 11 (2002) 819; G. Petö, A. Karacs, Z. Pászti, L. Guczi, T. Divinyi, A. Joób, Appl. Surf. Sci. 186 (2002) 7; M. Bereznai, I. Pelsöczi, Z. Tóth, K. Turzó, M. Radnai, Z. Bor, A. Fazekas, Biomaterials 24 (2003) 4197; A. Karacs, A. Joob-Fancsaly, T. Divinyi, G. Peto, G. Kovach, Mat. Sci. Eng. C 23 (2003) 431; C. Hallgren, H. Reimers, H. D. Chakarov, J. Gold, A. Wennerberg, Biomaterials 24 (2003) 701; S. A. Cho, S. K. Jung, Biomaterials 24 (2003) 4859; M. Trtica, B. Gakovic, D. Batani, T. Desai, P. Panjan, B. Radak, Appl. Surf. Sci. 253 (2006) 2551), electrochemical treatment (C. Madore, O. Piotrowski, D. Landolt, J. Electrochem. Soc. 146(7) (1999) 2526), and the combinations of the various methods above (D. L. Cochran, J. Simpson, H. P. Weber, D. Buser, Int. J. Oral Maxillofacial Implants 9 (1994) 289; R. V. Bathomarco, G. Solorzano, C. N. Elias, R. Prioli, Appl. Surf. Sci. 233; H. J. Ronold, S. P. Lyngstadaas, J. E. Ellingsen, Biomaterials 24 (2003) 4559; P. F. Chauvy, P. Hoffman, D. Landolt, Appl. Surf. Sci. 208-209 (2003) 165; C. Jaeggi, P. Kern, J. Michler, T. Zehnder, H. Siegenthaler, Surface & Coatings Technology 200 (2005) 1913). Recent studies have shown that laser processing of implant surfaces provides both suitable surface topography and less surface contamination as compared with other methods (A. Gaggl, G. Schultes, W. D. Müller, H. Kärcher, Biomaterials 21 (2000) 1067). Another advantage of laser technique is that the technique is also suitable for texturing of implants of more complicated shapes (D. M. Brunette, P. Tengvall, M. Textor, P. Thomsen, Titanium in Medicine: Material Science, Surface Science, Engineering, Biological Responses and Medical Applications, Springer, Berlin, 2001). In the past, surface structures has been produced using long-pulse lasers, including nanosecond Nd:YAG laser (A. Joób-Fancsaly, T. Divinyi, A. Fazekas, Cs. Daroczi, A. Karacs, G. Petö, Smart Mater. Struct. 11 (2002) 819; G. Petö, A. Karacs, Z. Pászti, L. Guczi, T. Divinyi, A. Joób, Appl. Surf. Sci. 186 (2002) 7; A. Karacs, A. Joob-Fancsaly, T. Divinyi, G. Peto, G. Kovach, Mat. Sci. Eng. C 23 (2003) 431; C. Hallgren, H. Reimers, H. D. Chakarov, J. Gold, A. Wennerberg, Biomaterials 24 (2003) 701), copper vapor laser (R. Stangl, B. Rinne, S. Kastl, C. Hendrich, European Cells and Materials 2 (2001) 1), nanosecond excimer lasers (J. L. Ricci, H. Alexander, Key Engineering Materials 198-199 (2001) 179; M. Bereznai, I. Pelsöczi, Z. Tóth, K. Turzó, M. Radnai, Z. Bor, A. Fazekas, Biomaterials 24 (2003) 4197) picosecond Nd:YAG laser (M. Trtica, B. Gakovic, D. Batani, T. Desai, P. Panjan, B. Radak, Appl. Surf. Sci. 253 (2006) 2551), and sub-picosecond excimer laser (M. Bereznai, i. Pelsöczi, Z. Tóth, K. Turzó, M. Radnai, Z. Bor, A. Fazekas, Biomaterials 24 (2003) 4197). More recently, with the advent of ultrafast laser techniques, femtosecond lasers have become an advanced tool for materials processing. Comparative studies of laser materials processing (B. N. Chichkov, C. Momma, S. Nolte, F. von Alvensleben, A. Tunnermann, Appl. Phys. A 63 (1996) 109; A. Semerok, C. Chaleard, V. Detaille, J.-L. Lacour, P. Mauchin, P. Meynadier, C. Nouvellon, B. Salle, P. Palianov, M. Perdrix, G. Petite, Appl. Surf. Sci. 138-139 (1999) 311; V. Margetic, A. Pakulev, A. Stockhaus, M. Bolshov, K. Niemax, R. Hergenröder, Specrochim. Acta B 55 (2000) 1771; R. Le Harzic, N. Huot, E. Audouard, C. Jonin, P. Laporte, S. Valette, A. Fraczkiewicz, R. Fortunier, Appl. Phys. Lett. 80 (2002) 3886) have demonstrated that femtosecond lasers have advantages over nanosecond lasers in aspects of higher precision, reduced heat-affected zone, and smaller amount of debris around the ablated spot.

In this paper, we perform the first detailed study of surface structures produced by femtosecond laser treatment of titanium surfaces. The effects of laser fluence and the number of applied pulses on laser-induced surface topography are studied. We find that the femtosecond laser produces a large variety of nanostructures (nanopores, nanoprotrusions) with a size down to 20 nm, multiple parallel grooved surface patterns with a period on the sub-micron level, microroughness in the range of 1-15 μm with various configurations, smooth surface with smooth micro-inhomogeneities, and smooth surface with sphere-like nanostructures down to 10 nm. Also, we have determined the optimal conditions for producing these surface structural modifications. Our results suggest that femtosecond laser treatment can produce a richer variety of surface structures on titanium for implants and other biomedical applications than long-pulse laser treatments.

### Example 5—Experimental

Commercially pure titanium flat plates with a dimension of 15×17×1.5 mm are used in our experiment. The plates were mechanically polished using 0.1-μm-grade aluminum oxide powder and further cleaned with acetone. For surface texturing, we use an amplified Ti:sapphire laser system that generates 65-fs laser pulses with the pulse energy over 1 mJ at a 1-kHz repetition rate with a central wavelength of 0.8 μm. The laser beam is horizontally polarized and is focused at normal incidence onto a vertically standing titanium sample in air at a pressure of 1 atm. For the laser beam focusing, we use an achromatic lens with a focal length of 20 cm. The laser fluence of the incident light is varied by changing the distance between the focusing lens and the sample. The diameter of laser-irradiated spots on titanium sample is varied from 100 to 1200 μm. The number of laser shots, N, applied to the sample is selected with an electromechanical shutter. The surface structuring of titanium is studied following the treatment with laser fluence of F=0.067, 0.084, 0.16, 0.35, 0.48, and 2.9 J/cm² and the number of applied pulses, N, in the range of 1-30,000. Following femtosecond laser treatment, the topography of surface modifications is studied using a SEM.

### Example 5—Results

As a reference, FIG. 26(a) shows a SEM image of the titanium surface prior to laser irradiation. FIGS. 26(b) through 26(d) demonstrate surface topography produced by femtosecond laser processing at near-damage-threshold fluence of F=0.067 J/cm² for different numbers of laser shots, where the characteristic features are random nanopores and sphere-like nanoprotrusions with the size down to about 15-20 nm. Laser-induced surface nano-topography depends on both the number of applied pulses and laser fluence. At higher fluence of F=0.084 J/cm², typical nanoroughness produced is shown in FIGS. 27(a) through 27(d), where the average size of the nanostructures at this higher fluence is larger than those at lower fluence in FIG. 1. For N>10-15, periodic ordering of surface nanoroughness begins to occur. FIGS. 28 and 29 show some typical periodic patterns for laser fluences F=0.067 and 0.084 J/cm², respectively. The period of the grooves is about 0.53 am. These periodic patterns with sub-micron periods are covered with nanoroughness, as shown in details in FIGS. 28(d) and 29(d). With increasing laser fluence, the periodic patterns are less likely produced and microroughness becomes a more dominant surface structure. FIG. 30 shows surface topography produced following treatment at F=0.16 J/cm² at various N. At this middle-level laser fluence, pure nanoroughness is observed only after one-shot laser processing [FIG. 30(a)]. A clear microscale roughness covered with nanoroughness develops after 20-shot treatment [FIG. 30(b)]. With further increasing N, microroughness continues to develop with deepening of cavities [FIG. 30(c)]. At a large enough N, columnar surface micro-structures covered with nanoroughness are seen in FIG. 30(d). At higher laser fluence of F=0.35 J/cm², a combination of nano- and micro-structures is produced after only one laser shot, as shown in FIG. 31(a). With increasing N, columnar microstructures rapidly develop as the dominating structures [see FIGS. 31(b)-31(d)]. When the laser fluence is increased to the level of F=0.48 J/cm², a different type of surface microstructures is observed, as shown in FIGS. 32(a)-32(c). At this laser fluence and for N>1000, a pore of the size of the focused laser beam can be created. An example of such a pore with the diameter of 350 μm is shown in FIG. 32(d), where microstructures are also seen at bottom of the pore. At the highest fluence used in our experiment, F=2.9 J/cm², one laser shot can produce surface melting over the entire irradiated surface area, and resolidification of this surface melt results in a smooth surface covered with some micro-inhomogeneities as shown in FIG. 33(a). Following two-pulse irradiation, an even smoother surface is seen in FIG. 33(b). A magnified picture showing nanoscale features of such smooth surfaces is shown in FIG. 33(c). A detail picture of the titanium surface after four laser shots is shown in FIG. 33(d), where one can see nanoscale structures as small as down to 10 nm. The smooth surface is usually produced with a low number of laser shots (N<10). At a larger N (N>10), micro-inhomogeneities develop rapidly and eventually a crater of the size of the focused laser beam can be formed.

### Example 5—Discussion

In numerous studies in the past (D. M. Brunette, P. Tengvall, M. Textor, P. Thomsen, Titanium in Medicine: Material Science, Surface Science, Engineering, Biological Responses and Medical Applications, Springer, Berlin, 2001; N. Sykaras, A. M. Iacopino, V. A. Marker, R. G. Triplett, R. D. Woody, Int. J. Oral Maxillofacial Implants 15 (2000) 675; F. H. Jones, Surf. Sci. Rep. 42 (2001) 75), it has been shown that implant surface topography is an important factor affecting the behaviors of both proteins and cells on the implant surfaces. It is generally accepted (D. M. Brunette, P. Tengvall, M. Textor, P. Thomsen, Titanium in Medicine: Material Science, Surface Science, Engineering, Biological Responses and Medical Applications, Springer, Berlin, 2001; B. Kasemo, J. Gold, Adv. Dent. Res. 13 (1999) 8; A. S. G. Curtis, C. D. W. Wilkinson, J. Biomater. Sci. Polymer Edn, 9 (1998) 1313) that proteins typically respond to surface structural features (pits, pillars, steps) about 1-10 nm, while cells can be sensitive to structural features on the scale of 15 nm-100 μm. It was also found that structured implants have a better mechanical interlocking of the bone-implant interfaces than smooth implant surfaces due to an increased surface area. Also, it has been reported that extended parallel groove structures may cause cells to align and migrate along the grooves, a contact guidance phenomenon (D. M. Brunette, P. Tengvall, M. Textor, P. Thomsen, Titanium in Medicine: Material Science, Surface Science, Engineering, Biological Responses and Medical Applications, Springer, Berlin, 2001; F. H. Jones, Surf. Sci. Rep. 42 (2001) 75; A. S. G. Curtis, C. D. W. Wilkinson, J. Biomater. Sci. Polymer Edn. 9 (1998) 1313). Our SEM study shows that all these types of surface textures can be produced by femtosecond laser treatment, and below we will discuss mechanisms and optimal conditions for producing these structures on titanium.

### Example 5—Discussion—Nanostructures

Little work has been done on laser fabrication of surface nanostructures on titanium. Previously, it was reported that nanoscale hillocks with the size down to 50 nm are produced following nanosecond Nd:glass laser treatment, and more importantly, it was also shown that osseointegration of dental implants is enhanced with the density of the nanoscale elements (A. Joób-Fancsaly, T. Divinyi, A. Fazekas, Cs. Daroczi, A. Karacs, G. Petõ, Smart Mater. Struct. 11 (2002) 819). Our study shows that femtosecond laser technique can produce even a larger variety of both pure nanostructures [FIGS. 26(b)-26(d), 27(a)-27(d), and 33(c)] and various combinations of micro- and nanostructures [FIGS. 28(d), 29(d), 30, 31]. There are two types of pure nanostructures observed in our experiment. The first type [FIGS. 26(b)-26(d), 27(a)-27(d)] is produced at low laser fluence (near the damage threshold) and a low number of laser shots, and the size of these nanostructures is down to 20 nm. The second type [FIGS. 33(c) and 33(d)] is produced at high fluence and low N when laser irradiation causes the surface to melt uniformly over the entire irradiated area; the size of these nanostructures is down to 10 nm.

Examination of shot-to-shot SEM images of surface topography suggests the following mechanism for the formation of nanostructures of the first type. It is seen from FIG. 26(d) that a nanopore is always accompanied by a nearby nanoprotrusion, indicating a nanoscale material relocation to an adjacent site. This one-to-one nanoscale pores and protrusions occur randomly over the laser spot, suggesting an initial non-uniform laser energy deposition. When the incident laser fluence is close to the laser damage threshold, spatial nonuniformity in the deposited laser energy can produce a melt at localized nanoscale sites within the irradiated spot. Once the localized nanoscale melt has been formed, a high radial temperature gradient in a nanomelt can induce a radial surface tension gradient that expels the liquid to the periphery of the nanomelt (J. Koch, F. Korte, T. Bauer, C. Fallnich, A. Ostendorf, B. N. Chichkov, Appl. Phys. A 81 (2005) 325). This will lead to the formation of nanocavities and nanoprotrusions due to fast freezing of the expelled liquid on the boundary with the solid state material. These initially induced surface random nanostructures enhance the absorption of laser light (A. Y. Vorobyev, C. Guo, Phys. Rev. B 72 (2005) 195422) and facilitate further growth of surface nanoroughness with increasing the number of laser shots due to the increased spatial non-uniform energy absorption. When laser fluence is sufficiently high to produce ablation, particles will be ejected from the nanomelts and produce a recoil pressure that squirts the liquid metal outside of the nanomelt. It should be noted that for multi-pulse ablation, the repeating vaporization and re-deposition of nanoparticles back onto the surface can also promote the surface nanostructuring. As seen from FIGS. 26 and 27, the average size and density of femtosecond laser-induced nanostructural features can be controlled by varying both the laser fluence and number of laser shots.

Mechanisms for the formation of nanostructures of the second type cannot be straightforwardly derived from our SEM study. However, we note that the formation of these nanostructural features can be due to redeposition of ablated nanoparticles back onto the irradiated surface. We note that this type of nanoscale structures seems to be observed following picosecond laser treatment (M. Trtica, B. Gakovic, D. Batani, T. Desai, P. Panjan, B. Radak, Appl. Surf. Sci. 253 (2006) 2551). However, the number of nanostructures following our femtosecond laser treatment is far greater.

### Example 5—Discussion—Multiple Parallel Grooved Surface Patterns

Multiple parallel grooved surface patterns for biomedical applications are commonly produced using lithographic (D. M. Brunette, P. Tengvall, M. Textor, P. Thomsen, Titanium in Medicine: Material Science, Surface Science, Engineering, Biological Responses and Medical Applications, Springer, Berlin, 2001) or laser holographic (P. Clark, P. Connolly, A. S. G. Curtis, J. A. T. Dow, C. D. W. Wilkinson, J. Cell Sci. 99 (1991) 70; F. Yu, P. Li, H. Shen, S. Mathur, C. M. Lehr, U. Bakowsky, F. MOcklich, Biomaterials 26 (2005) 2307) techniques. However, fabrication of this type of patterns on biomaterials using a single laser beam has not yet been studied despite of its simplicity. Below, we discuss the optimal conditions for producing these structures and explain the physical mechanisms of their formation.

Our study shows that optimal conditions for producing periodic groove patterns on titanium are at near-damage-threshold fluence and with the laser shot number in the range between 20 and 800. In the past, multiple parallel grooved surface patterns have been produced by long-pulse lasers and are known as laser-induced periodic surface structures (LIPSSs) (D. C. Emmony, R. P. Howson, L. J. Willis, Appl. Phys. Lett. 23 (1973) 598; Z. Guosheng, P. M. Fauchet, A. E. Siegman, Phys. Rev. B 26 (1982) 5366; J. F. Young, J. E. Sipe, H. M. van Driel, Phys. Rev. B 30 (1984) 2001; M. N. Libenson, A. G. Rumyantsev, Opt. Spektrosk. 60(4) (1986) 412; S. E. Clark, D. C. Emmony, Phys. Rev. B 40 (1989) 2031; A. M. Bonch-Bruevich, M. N. Libenson, V. S. Makin, V. V. Trubaev, Opt. Eng. 31(4) (1992) 718). The formation of LIPSSs on metals is believed resulting from the interference of the incident laser light with the excited surface plasmon polaritons that result in spatial periodic energy distribution on the surface [45,47,48]. (M. N. Libenson, A. G. Rumyantsev, Opt. Spektrosk. 60(4) (1986) 412; A. M. Bonch-Bruevich, M. N. Libenson, V. S. Makin, V. V. Trubaev, Opt. Eng. 31(4) (1992) 718; J. Wang, C. Guo, Appl. Phys. Lett. 87 (2005) 251914). Usually, LIPSS shows a regular groove structure with a period on the incident laser wavelength scale and is oriented perpendicularly to the polarization of the incident light. Our results of the evolution of surface structural modifications on titanium suggest the following mechanism for the formation of the observed LIPSSs. In our experiment, the first few laser shots produce sparsely and randomly distributed nanostructures. It is known that propagating cylindrical surface plasmons can be excited by coupling laser energy into nanoroughness, and this can give rise to their interference with the incident light. This interference will, first, cause the formation of intermediate periodic surface structures in localized areas of the irradiated spot. An example of such intermediate periodic surface structure can be seen in FIG. 26(c). With further increasing the number of laser shots, the number of intermediate periodic structures will grow as well as the area occupied by these structures. The developed intermediate periodic surface structures will further excite propagating plane surface plasmons and their interference with the plane incident laser light wave will, finally, result in the permanent extended periodic grating.

For linearly polarized incident laser light, the period d of the surface grating formed due to the interference between the incident laser light wave and the excited surface plasmon wave is given by [47] d=λ/(η±sin θ) with g∥E, where in this equation λ is the incident light wavelength, η=Re[ε/(ε+1)]^{1/2} is the real part of the effective refractive index of the air-metal interface for surface plasmons, ε is the dielectric constant of the metal, θ is the laser light incidence angle, g is the grating vector, and E is the electrical field vector of the incident wave. The above equation shows that the period of laser-fabricated grating can be varied by changing the laser wavelength, the incidence angle, or the real part of the effective refractive index. An important parameter affecting the cell behavior is known to be groove depth (D. M. Brunette, P. Tengvall, M. Textor, P. Thomsen, Titanium in Medicine: Material Science, Surface Science, Engineering, Biological Responses and Medical Applications, Springer, Berlin, 2001), and this parameter in fabricating LIPSSs can be controlled by the number of applied laser shots.

A unique feature of the periodic groove structures produced here is that both ridges and grooves are covered with nanoroughness following femtosecond laser treatment, in contrast to rectangular surface grooves fabricated using lithography techniques that usually have smooth ridges and rough floors (D. M. Brunette, P. Tengvall, M. Textor, P. Thomsen, Titanium in Medicine: Material Science, Surface Science, Engineering, Biological Responses and Medical Applications, Springer, Berlin, 2001).

### Example 5—Discussion—Microroughness

Laser microtexturing of titanium has been studied in the past using long-pulse lasers (A. Gaggl, G. Schultes, W. D. Müller, H. Kärcher, Biomaterials 21 (2000) 1067; J. L. Ricci, H. Alexander, Key Engineering Materials 198-199 (2001) 179; A. Joób-Fancsaly, T. Divinyi, A. Fazekas, C s. Daroczi, A. Karacs, G. Petõ, Smart Mater. Struct. 11 (2002) 819; G. Petö, A. Karacs, Z. Pászti, L. Guczi, T. Divinyi, A. Joób, Appl. Surf. Sci. 186 (2002) 7; M. Bereznai, I. Pelsöczi, Z. Tóth, K. Turzó, M. Radnai, Z. Bor, A. Fazekas, Biomaterials 24 (2003) 4197; A. Karacs, A. Joob-Fancsaly, T. Divinyi, G. Peto, G. Kovach, Mat. Sci. Eng. C 23 (2003) 431; C. Hallgren, H. Reimers, H. D. Chakarov, J. Gold, A. Wennerberg, Biomaterials 24 (2003) 701; S. A. Cho, S. K. Jung, Biomaterials 24 (2003) 4859; M. Trtica, B. Gakovic, D. Batani, T. Desai, P. Panjan, B. Radak, Appl. Surf. Sci. 253 (2006) 2551). It has been shown that laser processing of implant surfaces provides both suitable surface microstructures and the least surface contamination as compared with other methods (A. Gaggl, G. Schultes, W. D. Müller, H. Kärcher, Biomaterials 21 (2000) 1067). As shown in FIGS. 30(b)-30(d), 31(a)-31(d), 32(a)-32(c), and 33(a), a rich variety of microstructures can be produced by femtosecond laser treatment, and these structures can be characterized as the following two types. The first type [see FIGS. 30(b)-30(d), 31(a)-31(d), 32(a)-32(c)] is produced at the middle levels of the laser fluence in our experiment (F=0.16 and 0.35 J/cm²). The characteristic size of this type of microroughness is in the range of 1-15 μm. Both the characteristic size and configuration of the surface microroughness can be controlled by both laser fluence and the number of applied shots. This type of microroughness seems to be only produced by femtosecond laser treatment. The second type of microroughness [see FIG. 33(a)] is characterized by a smooth surface with smooth micro-inhomogeneities. This type of microroughness is produced at the highest laser fluence in our experiment (F=2.9 J/cm²) when melting occurs over the entire irradiated area. If the melted surface has some structural inhomogeneities, fast resolidification of this melted surface may result in smooth micro-scale roughness. We note that this type of surface microroughness is also observed following long-pulse laser treatment (A. Joób-Fancsaly, T. Divinyi, A. Fazekas, Cs. Daroczi, A. Karacs, G. Petõ, Smart Mater. Struct. 11 (2002) 819; G. Petö, A. Karacs, Z. Pászti, L. Guczi, T. Divinyi, A. Joób, Appl. Surf. Sci. 186 (2002) 7; A. Karacs, A. Joob-Fancsaly, T. Divinyi, G. Peto, G. Kovach, Mat. Sci. Eng. C 23 (2003) 431). However, our study shows that femtosecond laser treatment produces a richer variety of microscale structures, as well as combinations of nano- and microstructures.

### Example 5—Discussion—Smooth Surfaces

Some parts of implant surfaces may be required to be smooth (D. L. Cochran, J. Simpson, H. P. Weber, D. Buser, Int. J. Oral Maxillofacial Implants 9 (1994) 289; M. Quirinen, C. M. Bollen, W. Papaioannou, J. Van Eldere, D. van Steenberghe, Int. J. Oral Maxillofacial Implants, 11 (1996) 169). Previously, nanosecond excimer lasers have been used for polishing machined titanium implants, and effects of both polishing and cleaning of the surfaces have been reported (M. Bereznai, I. Pelsöczi, Z. Tóth, K. Turzó, M. Radnai, Z. Bor, A. Fazekas, Biomaterials 24 (2003) 4197). Our study shows that smoothed surface can be also obtained with femtosecond laser treatment, as shown in FIG. 33(b).

### Example 5—Discussion—

### Pores with Diameter of 100-400 μm

It is known that open pores with a diameter in the range of 100-400 μm can improve the strength of bone-implant interfaces (B. E. McKoy, Y. H. An, R. J. Freidman, in: Y. H. An, R. A. Draughn (Eds.), Mechanical testing of bone and the bone-implant-interface, CRC Press, Boca Raton, 2000, pp. 439-461). Recently, long-pulse lasers have been used for fabricating 100-300 μm pores on Ti6Al4V implants (M. Müller, F. F. Hennig, T. Hothorn, R. Stangl, Journal of Biomechanics 39 (2006) 2123). Our study shows that pores of this size can be easily produced with femtosecond laser treatment, as shown in FIG. 32(d). We note that we can further produce various surface structures on the pore bottom through femtosecond laser treatment.

### Example 5—Conclusion

In this paper, we perform a detailed study of surface structures produced by femtosecond laser treatment of titanium surfaces. The effects of laser fluence and the number of applied pulses on laser-induced surface topography are studied. We find that the femtosecond laser produces a large variety of nanostructures (nanopores, nanoprotrusions) with a size down to 20 nm, multiple parallel grooved surface patterns with a period on the sub-micron level, microroughness in the range of 1-15 μm with various configurations, smooth surface with smooth micro-inhomogeneities, and smooth surface with sphere-like nanostructures down to 10 nm. Also, we have determined the optimal conditions for producing these surface structural modifications. Our results suggest that femtosecond laser treatment can produce a richer variety of surface structures on titanium for implants and other biomedical applications than long-pulse laser treatments. Finally, we would like to remark that femtosecond laser surface texturing can be also used for decorative processing of titanium in jewelry industry, especially for titanium piercing jewelry due to biological compatibility of titanium.

### Example 6

Another application of femtosecond laser surface structuring to produce the materials processing of the present invention is to provide the controllable modification of the optical properties of metals, where these optical properties range from the UV to THz spectral range, and where the modifications may be used to create various black, grayed, and colored metals.

As an example, FIG. 34 shows the % reflectance material from 0.25 to 2.5 μm of “black” aluminum obtained by the materials processing methods of the present invention. These total reflectance measurements were performed using Perkin-Elmer spectrometer Lambda 900 with an integrating sphere. In the visible this aluminum appears pitch black as demonstrated in FIG. 35(a).

By varying the materials processing of the regimes of the present invention, we have also produced aluminum that appears to be various shades of gray, depending upon the conditions used. Thus in the case of the grayed aluminum shown in FIG. 35(b), the materials processing was performed at laser fluence F=7.9 J/cm², a scanning speed of the laser beam across the surface of the Al of v=1 mm/s, and translation between scanning lines S=100 μm. The two gray shades of aluminum shown in FIG. 35(b) are obtained by varying the laser pulse repetition rate (f=100 Hz for the darker shade and 93 Hz for the lighter one). The spectral reflectance of this darker gray aluminum sample is shown in FIG. 34.

In addition to producing various shades of gray as discussed above, the materials processing methods of the present invention can also produce colored metals, i.e., metals that appear to have a particular color or that appear to have multiple colors.

To produce color metals we tried two types of femtosecond laser processing techniques. The first technique is to tailor laser-induced surface random structures, and the second technique is to produce femtosecond laser-induced periodic surface structures (FLIPSS). The major difference in the colored metals produced by these two types of techniques is that the colored metals produced by the first technique exhibit the same apparent color at various viewing angles, while the colored metals produced by the second technique exhibit different colors at different viewing angles due to the grating effect.

FIG. 35(c) shows a picture of a colored aluminum produced by the controlled tailoring of random surface roughness in such a way that this aluminum appears golden because the tailored surface structures preferentially enhance the absorption at blue and green wavelengths. The spectral reflectance of the golden aluminum is shown in FIG. 34.

Colored metals produced by the second technique, FLIPSS, exhibit different colors at different viewing angles. FIG. 36 shows various colors of an aluminum sample structured with FLIPSS under experimental conditions of F=0.05 J/cm², f=83 Hz, v=1 mm/s, and S=100 μm. The spectral reflectance of the color aluminum structured with FLIPSS is shown in FIG. 34. Structuring with FLIPSS can cause a polarization effect on the absorption of light that provides an additional way for controlling the optical properties. The size of the optically modified metal surface area can be as small as a tightly focused laser spot, i.e. down to about 10 μm, or as large as needed when a scanning laser beam is used (for example, FIGS. 35 and 36 show samples with structurally modified area of about 24 mm in diameter).

Given the additional advantages of laser processing such as low contamination and capability to process complicated shapes, the black, grayed, and colored metals created by femtosecond laser surface structuring have numerous potential applications in such areas including, but not limited to, photonics, plasmonics, optoelectronics, stealth technology, thermal radiation sources, solar cell absorbers, radiative heat transfer devices, infrared sensing, biooptical devices, thermophotovoltaics, and airborne/spaceborne devices.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A method of altering a material comprising exposing the material to one or more pulses of a femtosecond duration laser beam.

2. The method of claim 1, where the material is a bulk metal.

3. The method of claim 2, where the bulk metal is selected from the group consisting of gold, silver, titanium, aluminum, platinum, stainless steel, and copper.

4. The method of claim 1, where the material is a thin film.

5. The method of claim 1, where the material is selected from the group consisting of semiconductors and dielectrics.

6. The method of claim 1, where the fluence of the laser beam is less than 10 J/cm².

7. The method of claim 1, where the central wavelength of the femtosecond duration laser beam is about 0.8 μm.

8. The method of claim 1, where the exposure of the material to the laser beam is done in a non-vacuum environment.

9. The method of claim 1, where the exposure of the material to the laser beam is done in a vacuum environment.

10. The method of claim 1, where the number of laser pulses is at least 2.

11. The method of claim 10, where the fluence of the laser beam is less than 10 J/cm².

12. The method of claim 10, where the fluence of the laser beam is less than 1 J/cm².

13. The method of claim 1, where the number of laser pulses is at least 5.

14. The method of claim 10, where the fluence of the laser beam is less than 10 J/cm².

15. The method of claim 10, where the fluence of the laser beam is less than 1 J/cm².

16. The method of claim 1, where the area of the material altered is at least 0.1 cm².

17. The method of claim 1, where the alteration of the material produces an absorptance of the material of at least 0.9.

18. The method of claim 1, where the alteration of the material produces a colored metal.

19. The method of claim 1, where the alteration of the material produces a metal which has a surface dominated by nanostructures.

20. A material having nanoprotrusions with spherical tips of diameter of up to about 75 nm.

21. A material having an absorptance of at least 0.9.
